(19) United States
(12) Patent Application Publication
(10) Pub. No.: US 2026/0205761 A1
(43) Pub. Date: Jul. 16, 2026

(54) RENDERING OF REVERBERATION IN CONNECTED SPACES

(71) Applicant: Telefonaktiebolaget LM Ericsson (publ), Stockholm (SE)

(72) Inventors: Werner DE BRUIJN, Stockholm (SE); Antti ERONEN, Tampere (FI); Jaakko HYRY, Oulu (FI); Otto HARJU, Tampere (FI); Jürgen HERRE, Erlangen (DE)

(73) Assignee: Telefonaktiebolaget LM Ericsson (publ), Stockholm (SE)

(21) Appl. No.: 19/137,864

(22) PCT Filed: Dec. 15, 2023
(86) PCT No.: PCT/EP2023/085989

§ 371 Date: Jun. 11, 2025

Related U.S. Application Data
(60) Provisional application No. 63/432,844, filed on Dec. 15, 2022.

(51) Int. Cl. H04S 7/00

(52) U.S. Cl. CPC H04S 7/306

(57) ABSTRACT

A method for producing an input signal for a first space of an XR scene based on a first sound source in a second space of the XR scene, wherein the first space is connected, either directly or indirectly, to the second space via one or more portals including at least a first portal. The method includes obtaining a direct propagation value, wherein the direct propagation value is indicative of an amount or portion of source power associated with the first sound source in the second space that is propagated directly from the first sound source through the one or more portals into the first space. The method further includes producing the input signal for the first space using the direct propagation value and an audio signal associated with the first sound source.

### TECHNICAL FIELD

Disclosed are embodiments related to rendering reverberation in a first space connected to a second space via a portal.

### BACKGROUND

Extended reality (XR) system, for example, virtual reality (VR) systems, augmented reality (AR) systems, mixed reality (MR) systems, etc., generally include an audio renderer for rendering audio to the user of the XR system. The audio renderer typically contains a reverberation processor to generate late and/or diffuse reverberation that is rendered to the user of the XR system to provide an auditory sensation of being in the XR scene that is being rendered. The generated reverberation should provide the user with the auditory sensation of being in the acoustic environment (AE), a.k.a., “space”, corresponding to the XR scene, for example, a living room, a gym, an outdoor environment, etc.

Reverberation is one of the most significant acoustic properties of a room. Sound produced in a room will repeatedly bounce off reflective surfaces such as the floor, walls, ceiling, windows or tables while gradually losing energy. When these reflections mix with each other, the phenomena known as “reverberation” is created. Reverberation is thus a collection of many reflections of sound.

Two of the most fundamental characteristics of the reverberation in any space, real or virtual, are: 1) the reverberation time and 2) the reverberation level, i.e., how strong or loud the reverberation is, for example, relative to the power or direct sound level of sound sources in the space.

The reverberation time is a measure of the time required for reflected sound to “fade away” in an enclosed space after the source of the sound (“sound source”) has stopped. It is important in defining how a room will respond to acoustic sound. Reverberation time depends on the amount of acoustic absorption in the space, being lower in spaces that have many absorbent surfaces such as curtains, padded chairs or even people, and higher in spaces containing mostly hard, reflective surfaces.

Conventionally, the reverberation time is defined as the amount of time the sound pressure level takes to decrease by 60 dB after a sound source is abruptly switched off. The shorthand for this amount of time is “RT60” (or, sometimes, T60).

Typically, for a reverberation processor used in an audio renderer, these two (and other) characteristics of generated reverberation may be controlled individually and independently. For example, it is typically possible to configure the reverberation processor to generate reverberation with a certain desired reverberation time and a certain desired reverberation level.

In an XR system, the characteristics of the generated reverberation are typically controlled by control information, e.g., special metadata contained in the XR scene description, e.g., as specified by the scene creator, which describes many aspects of the XR scene including its acoustical characteristics. The audio renderer receives this control information, e.g., from a bitstream or a file, and uses this control information to configure the reverberation processor to produce reverberation with the desired characteristics. The exact way in which the reverberation processor obtains the desired reverberation time and reverberation level in the generated reverberation may differ, depending on the type of reverberation algorithm that the reverberation processor uses to generate reverberation.

### Reverberation and Connected Spaces

As indicated above, one of the key aspects of immersive rendering of audio is the realistic rendering of reverberation associated with the virtual space of the XR scene. A special challenge is the realistic rendering of reverberation in spaces (a.k.a., “acoustic environments”) that are connected (or “coupled”) to another space via a “portal”, for example an open door, an open window, a partly transmissive window, a partly transmissive wall, etc. —i.e., anything through which sounds from one space can propagate to the connected space and vice versa.

One aspect of this is the realistic modeling and rendering of reverberation that is generated in a first space in response to direct sound of a sound source that is located in a second, connected space, that propagates to the first space directly via the portal between the two spaces, i.e., without first being reflected and/or reverberated in the second space. Another aspect is the realistic modeling and rendering of reverberation from the connected second space that propagates into the first space via the portal.

One solution for rendering reverberation is described in a working draft (WD1) of ISO/IEC 23090-4, MPEG-I Immersive Audio, output document of the 9 th meeting of MPEG WG 6 Audio Coding (hereafter “WD1 of ISO/IEC 23090-4”).

### SUMMARY

Certain challenges presently exist. For example, a practical rendering model and signal processing architecture for realistic rendering of reverberation generated in a space of an XR scene due to a sound source located in a connected space does not currently exist. The solution described in WD1 of ISO/IEC 23090-4 lacks rendering of reverberation in a first space (e.g., an active space) in response to a source located outside the first space (i.e., in a second space).

If sound sources outside of an active space, that is, a space where the listener is located, are not taken into account in generating reverberation in the active space, then no reverberation is generated in response to these external sound sources, which would be unnatural to the listener(s) located in the active space. Similarly, if a sound source is present in an active space that is connected to another highly reverberant space, then the sound of the source would naturally be expected to generate some reverberation in the connected space, and part of this reverberation would be expected to propagate back into the active space.

The current solution in WD1 of ISO/IEC 23090-4 renders the reverberation for each space using a feedback delay network (FDN) reverberator. There are methods for combining several of such FDN reverberators into a grouped feedback delay network (see, e.g., reference [2]) but such solutions easily become computationally too heavy for real time audio rendering.

Furthermore, existing XR audio rendering architectures are not optimized for handling reverberation due to sources outside of the active space, especially for XR scenes that consist of many connected spaces, all of which may contain any number of sound sources. Hence, an optimized rendering architecture is needed for the efficient handling of such cases.

Accordingly, in one aspect there is provided a method for producing an input signal for a first space of an XR scene based on a first sound source in a second space of the XR scene, wherein the first space is connected, either directly or indirectly, to the second space via one or more portals including at least a first portal. The method includes obtaining a direct propagation value, wherein the direct propagation value is indicative of an amount or portion of source power associated with the first sound source in the second space that is propagated directly from the first sound source through the one or more portals into the first space. The method further includes producing the input signal for the first space using the direct propagation value and an audio signal associated with the first sound source.

In another aspect there is provided a method for enabling the rendering of reverberation in a first space of an XR scene connected, either directly or indirectly, to a second space of the XR scene via one or more portals including at least a first portal, wherein a sound source is present in the second space. The method includes determining a direct propagation value, wherein the direct propagation value is indicative of an amount or portion of source power associated with the sound source, that is propagated directly from the sound source in the second space through the one or more portals to the first space. The method further includes storing and/or transmitting the direct propagation value or data from which the direct propagation value can be derived. The method may be performed by an audio encoder.

In another aspect there is provided a method for rendering of first-order reverberation in a first space of an XR scene. The method includes determining whether a first sound source is located in a second space. The method also includes determining whether there are one or more portals connecting the first space with the second space. The method also includes, as a result of determining that a first sound source is located in the second space and that there is at least a first portal connecting the first space with the second space, determining a first direct propagation value for the first sound source with respect to the first portal. The method also includes producing an input signal for the first space using the direct propagation value and an audio signal associated with the first sound source. The method further includes using the input signal for the first space to generate a reverberation signal for the first space.

In another aspect there is provided an apparatus for producing an input signal for a first space of an XR scene based on a first sound source in a second space of the XR scene, wherein the first space is connected, either directly or indirectly, to the second space via one or more portals including at least a first portal. The apparatus is configured to obtain a direct propagation value, wherein the direct propagation value is indicative of an amount or portion of source power associated with the first sound source in the second space that is propagated directly from the first sound source through the one or more portals into the first space. The apparatus is also configured to produce the input signal for the first space using the direct propagation value and an audio signal associated with the first sound source.

In another aspect there is provided an apparatus for enabling the rendering of reverberation in a first space of an XR scene connected, either directly or indirectly, to a second space of the XR scene via one or more portals including at least a first portal, wherein a sound source is present in the second space. The apparatus is configured to determine a direct propagation value, wherein the direct propagation value is indicative of an amount or portion of source power associated with the sound source, that is propagated directly from the sound source in the second space through the one or more portals to the first space. The apparatus is also configured to store and/or transmitting the direct propagation value or data from which the direct propagation value can be derived.

In another aspect there is provided an apparatus for rendering of first-order reverberation in a first space of an XR scene. The apparatus is configured to determine whether a first sound source is located in a second space. The apparatus is also configured to determine whether there are one or more portals connecting the first space with the second space. The apparatus is also configured to, as a result of determining that a first sound source is located in the second space and that there is at least a first portal connecting the first space with the second space, determine a first direct propagation value for the first sound source with respect to the first portal. The apparatus is also configured to produce an input signal for the first space using the direct propagation value and an audio signal associated with the first sound source. The apparatus is also configured to use the input signal for the first space to generate a reverberation signal for the first space.

In another aspect there is provided a computer program comprising instructions which when executed by processing circuitry of apparatus causes the apparatus to perform the methods disclosed herein. In one embodiment, there is provided a carrier containing the computer program wherein the carrier is one of an electronic signal, an optical signal, a radio signal, and a computer readable storage medium.

An advantage of the embodiments disclosed herein is that they enable a realistic and efficient rendering of reverberation in XR scenes with connected spaces.

### BRIEF DESCRIPTION OF THE DRAWINGS

The accompanying drawings, which are incorporated herein and form part of the specification, illustrate various embodiments.

FIG. 1A shows a system according to some embodiments

FIG. 1B shows a system according to some embodiments.

FIG. 2 illustrates a system according to some embodiments.

FIG. 3 illustrates a portal from a first space to a second space.

FIG. 4 illustrates vectors going from a point to portal opening vertices.

FIG. 5 illustrates a mesh.

FIG. 6 illustrates the concept of an interpolated direct propagation value grid for possible object source positions

FIG. 7 illustrates an efficient architecture for an audio renderer

FIG. 8 is a flowchart illustrating a process according to an embodiment.

FIG. 9 is a flowchart illustrating a process according to an embodiment.

FIG. 10 is a block diagram of an apparatus according to some embodiments.

FIG. 11A illustrates two spaces connected via a portal.

FIG. 11B illustrates two spaces connected via a portal.

FIG. 12 is a flowchart illustrating a process according to an embodiment.

FIG. 13 is a flowchart illustrating a process according to an embodiment.

### DETAILED DESCRIPTION

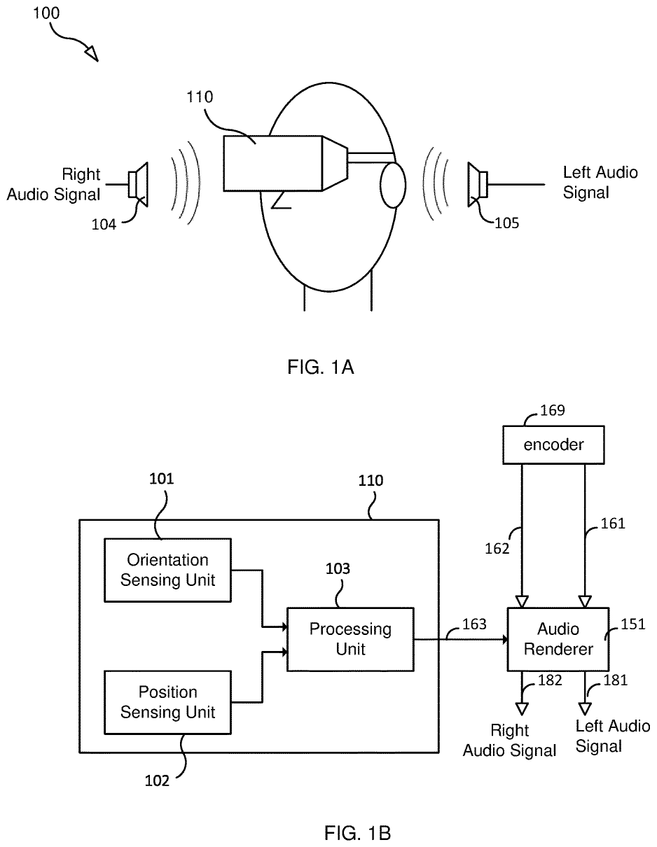

FIG. 1A illustrates an XR system 100 in which the embodiments disclosed herein may be applied. XR system 100 includes speakers 104 and 105 (which may be speakers of headphones worn by the user) and an XR device 110 that may include a display for displaying images to the user and that, in some embodiments, is configured to be worn by the listener. In the illustrated XR system 100, XR device 110 has a display and is designed to be worn on the user's head and is commonly referred to as a head-mounted display (HMD).

As shown in FIG. 1B, XR device 110 may comprise an orientation sensing unit 101, a position sensing unit 102, and a processing unit 103 coupled, directly or indirectly, to an audio render 151 for producing output audio signals, for example a left audio signal 181 for a left speaker and a right audio signal 182 for a right speaker as shown, using input audio signals 161, for example, encoded audio data, and metadata 162, which, in this example, is shown as being provided by an encoder 169. For example, encoder 169 may generate a bitstream containing the encoded audio data 161 and metadata 162.

Orientation sensing unit 101 is configured to detect a change in the orientation of the listener and provides information regarding the detected change to processing unit 103. In some embodiments, processing unit 103 determines the absolute orientation (in relation to some coordinate system) given the detected change in orientation detected by orientation sensing unit 101. There could also be different systems for determination of orientation and position, e.g. a system using lighthouse trackers (LIDAR). In one embodiment, orientation sensing unit 101 may determine the absolute orientation (in relation to some coordinate system) given the detected change in orientation. In this case the processing unit 103 may simply multiplex the absolute orientation data from orientation sensing unit 101 and positional data from position sensing unit 102. In some embodiments, orientation sensing unit 101 may comprise one or more accelerometers and/or one or more gyroscopes.

Audio renderer 151 produces the audio output signals based on input audio signals 161, metadata 162 regarding the XR scene the listener is experiencing, and information 163 about the location and orientation of the listener. The metadata 162 for the XR scene may include metadata for each object and audio element included in the XR scene, as well as metadata for the XR space (“acoustic environment”) in which the listener is virtually located. The metadata for an object may include information about the dimensions of the object and occlusion factors for the object. For example, the metadata may specify a set of occlusion factors where each occlusion factor is applicable for a different frequency or frequency range. The metadata 162 may also include control parameters, such as a reverberation time value, a reverberation level value, and/or absorption parameter(s).

Audio renderer 151 may be a component of XR device 110 or it may be remote from the XR device 110. For example, audio renderer 151, or components thereof, may be implemented in the cloud.

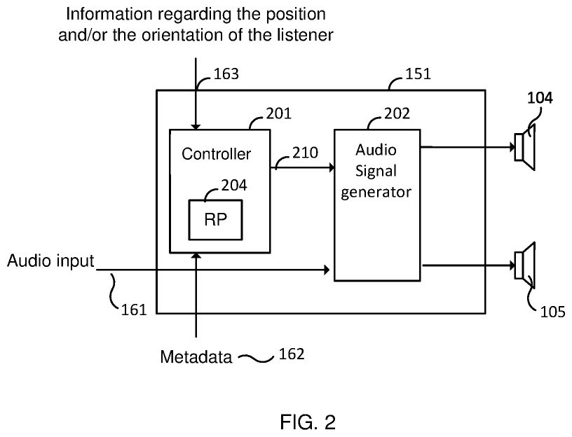

FIG. 2 shows an example implementation of audio renderer 151 for producing sound for the XR scene. Audio renderer 151 includes a controller 201 and an audio signal generator 202 for generating the output audio signal(s) (e.g., the audio signals of a multi-channel audio element) based on control information 210 from controller 201 and input audio 161. In this embodiment, controller 201 comprises a reverberation processor 204 for determining a scaling factor (a.k.a., direct propagation value) as described below.

In some embodiments, controller 201 may be configured to receive one or more parameters and to trigger audio signal generator 202 to perform modifications on audio signals 161 based on the received parameters, such as, for example, increasing or decreasing the volume level. The received parameters include information 163 regarding the position and/or orientation of the listener such as, for example direction and distance to an audio element, and metadata 162 regarding the XR scene. As noted above, metadata 162 may include metadata regarding the XR space in which the user is virtually located. For example, the metadata 162 may include information regarding the dimensions of the space, information about objects in the space, and information about acoustical properties of the space, as well as metadata regarding audio elements and metadata regarding an object occluding an audio element. In some embodiments, controller 201 itself produces at least a portion of the metadata 162. For instance, controller 201 may receive metadata about the XR scene and derive, based on the received metadata, additional metadata, such as, for example, control parameters. For instance, using the metadata 162 and position/orientation information 163, controller 201 may calculate one or more gain factors (g) (e.g., the above described scaling factor) for an audio element in the XR scene.

With respect to the generation of a reverberation signal that is used by audio signal generator 202 to produce the final output signals, controller 201 provides to audio signal generator 202 reverberation parameters, such as, for example, reverberation time and reverberation level for a space in the XR scene, and the above described scaling factor, so that audio signal generator 202 is operable to generate the reverberation signal. The reverberation time for the generated reverberation is most commonly provided to the reverberation processor 204 as an RT60 value, typically for individual frequency bands, although other reverberation time measures exist and can be used as well. In typical embodiments, the metadata 162 includes all of the necessary reverberation parameters (e.g., RT60 values and reverberation level values). But in embodiments in which the metadata does not include all necessary reverberation parameters, controller 201 may be configured to generate the missing parameters.

The reverberation level may be expressed in various formats. Typically, it will be expressed as a relative level. For example, it may be expressed as an energy ratio between direct sound and reverberant sound components (DRR) or it's inverse, i.e., the RDR energy ratio, at a certain distance from a sound source that is rendered in the XR environment. Alternatively, the reverberation level may be expressed in terms of an energy ratio between reverberant sound and total emitted energy or power of a source. In yet other cases, the reverberation level may be expressed directly as a level/gain for the reverberation processor.

In this context, the term “reverberant” may typically refer to only those sound field components that correspond to the diffuse part of the acoustical room impulse response of the acoustic environment, but in some embodiments it may also include sound field components corresponding to earlier parts of the room impulse response, e.g., including some late non-diffuse reflections, or even all reflected sound.

Other metadata describing reverberation-related characteristics of the acoustical environment that may be included in the metadata 162 include parameters describing acoustic properties of the materials of the environment's surfaces (describing, e.g., absorption, reflection, transmission and/or diffusion properties of the materials), or specific time points of the room impulse response associated with the acoustical environment, e.g. the time after the source emission after which the room impulse response becomes diffuse (sometimes called “pre-delay”).

All reverberation-related properties described above are typically frequency-dependent, and therefore their related metadata parameters are typically also provided and processed separately for a number of frequency bands.

### Embodiments

In one embodiment, there is provided a computationally efficient method for rendering of reverberation in response to sources located in connected spaces. The embodiments may also optionally include rendering of reverberation propagating from connected spaces, and/or the generation and rendering of further (“second-order”) reverberation in response to reverberation propagating from connected spaces in virtual acoustic systems.

In a real-life situation, the reverberation that is present in a given space may in general not only be generated in response to sound sources that are present within that same space, but may also (partly) be generated in response to sound sources that are located outside the space.

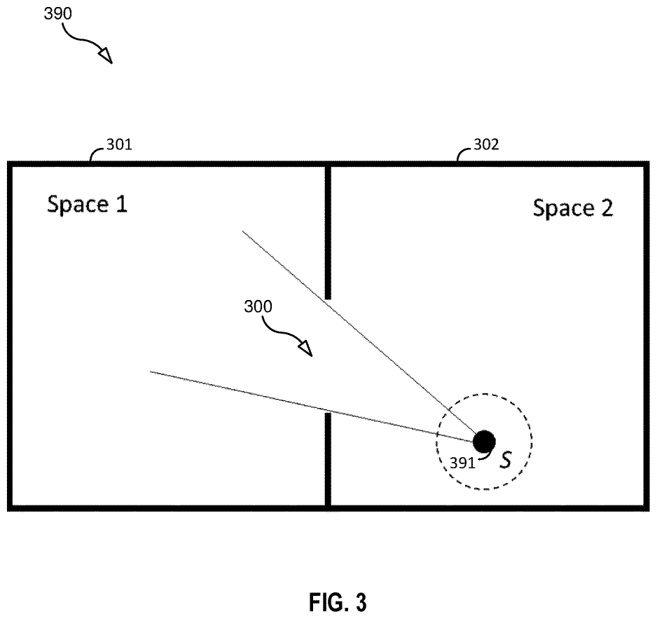

Consider the situation of FIG. 3, where a first space (Space 1) is connected to a second space (Space 2) via a portal 300. Initially, the assumption is that the portal is fully acoustically transparent, i.e., that it is completely “open”. For example, the assumption may be that the portal is an open door, an open window, or other open connection between the two spaces. A sound source S is located somewhere in Space 2.

The energy that is radiated by source S will generate reverberation in Space 2 (“Space 2 reverberation”), and some of that Space 2 reverberation will propagate through the portal to Space 1 where, in turn, it may generate further reverberation (“second-order reverberation”).

However, part of the energy that is radiated by source S may propagate directly through the portal, i.e., not as Space 2 reverberation, but as direct sound from source S. This direct sound that enters Space 1 through the portal generates reverberation in Space 1 that is a direct response to the sound emitted by source S.

Challenges addressed in this disclosure include: i) determining the amount or portion of direct sound energy/power radiated by sound source S that propagates directly through the portal into Space 1; ii) generating (and optionally rendering) reverberation in Space 1 that is consistent with the determined amount or portion of direct sound energy that is entering Space 1 through the portal; and iii) defining a suitable rendering architecture for the efficient handling of the above process, also in use cases with many connected spaces.

Further challenges include i) realistic rendering in Space 1 of Space 2 reverberation that propagates through the portal into Space 1, and, vice-versa, realistic rendering in Space 2 of Space 1 reverberation propagating back to Space 2 via the portal (this is essentially the same problem); and ii) realistic rendering in Space 1 of “second-order” reverberation that is generated in Space 1 in response to the Space 2 reverberation that propagates through the portal.

The situation and challenges described above are in principle independent of where a user of the XR system (a.k.a., “user” or “listener”) may be virtually located within the generated XR scene. However, depending on the space in which a listener is positioned, the relevance and/or order in which the different challenges occur may be different, and, accordingly, a renderer may be configured to carry out any of the processes described above in any combination or order, depending on the spaces in which the listener and sources are located.

To illustrate this, the different processes are separated into “first-order” and “second-order” processes. In the situation of FIG. 3, the “first-order processes” that take place include: (1) the generation of first-order Space 2 reverberation in Space 2; and the (2) generation of first-order reverberation in Space 1 due to the direct sound of source S that propagates through the portal; the “second-order processes” in this case include: (3) the generation of second-order reverberation in Space 1 in response to the first-order Space 2 reverberation that enters Space 1 through the portal; and (4) the generation of second-order Space 2 reverberation due to the first-order Space 1 reverberation entering Space 2 through the portal.

If a listener is located in Space 1, i.e., the sound source S is located in a space other than the space in which the listener is located, it is process (2) and (3) that result in sound that is rendered to the listener, while process (1) is needed to be able to carry out process (3). Process (4) may in this case not be considered relevant to carry out, since no listener is present in Space 2 that would hear this second-order reverberation in Space 2, and its result is also not needed to generate the sound that is rendered to the listener in Space 1.

In principle, the second-order processes may be followed by third-order etc. processes, e.g., propagating the second-order reverberation in Space 2 back into Space 1, but the perceptual relevance of these higher-order processes may be so small that they can be considered irrelevant to carry out and/or render.

If, on the other hand, the listener is located in Space 2 (i.e., the listener is in the same space as the sound source), then it is the first and fourth process that result in sound that is rendered to the listener, while the second process is needed to be able to carry out the fourth process. It is the third process that may be considered irrelevant to carry out and/or render in this case.

Determining the Amount or Portion of Direct Sound Source Power Propagating into the Connected Space Through the Portal

The amount or portion of power radiated by the sound source that propagates through the portal via a direct path depends on several factors, including: i) the position and size/shape of the portal, ii) the position of the sound source, iii) the directivity pattern of the sound source, and iv) the orientation of the sound source.

One method for determining the amount or portion of radiated source power that propagates directly through the portal is using a “line-of-sight” approach that, in one embodiment, includes the following steps:
(1) projecting (the edges of) the portal geometry on an imaginary sphere around the sound source;
(2) integrating the directivity pattern of the source over the sphere segment covered by the projection of the portal, taking into account the orientation of the sound source; and
(3) normalizing the obtained value by the surface area of the sphere to produce a direct propagation value for the source S in Space 2 with respect to the portal to Space 1, wherein the direct propagation value indicates the amount or portion of power radiated by the sound source that propagates directly through the portal.

The latter step normalizes the amount of power propagating directly through the portal with respect to the total amount of power radiated by an omnidirectional source that is driven with the same input signal. In many embodiments, the sphere is a unit sphere and the surface area of the unit sphere is 4 x.

If the directivity pattern of the source is normalized, i.e., it has a value of 1 in the source's direction of highest output, then this process will result in a value between 0 and 1. In case the portal is a flat surface then the maximum value is 0.5, since an omnidirectional source radiates a maximum of half of its power directly through a flat portal. An assumption here is that the directivity pattern is expressed in terms of the intensity/power that is radiated into individual directions, i.e., it is proportional to the square of the rms signal amplitude/pressure of the direct sound of the source measured for the individual directions at equal distance from the source.

The directivity pattern of the sound source is indicative of the amount of sound power that the sound source radiates into individual directions. A simple omnidirectional source radiates sound equally into all directions, so that the directivity pattern has the same value in all directions (1, in case the directivity pattern is normalized), but in general a sound source will radiate different amounts of power into different directions.

In an XR system, the directivity pattern of a sound source will typically be available directly from metadata 162 corresponding to the sound source. It may typically be provided as either (typically normalized) dB values for individual directions, corresponding to the (normalized) sound pressure level (SPL) measured in each direction around the sound source at equal distance, or as (typically normalized) linear gain values for individual directions.

Alternatively, the directivity pattern may be provided in some other suitable format, e.g., a spherical harmonics representation from which the directivity pattern can be derived for an arbitrary desired set of directions.

In yet other cases, a directivity pattern may be provided in terms of “directivity factors” for individual directions, where the directivity factor of a particular direction quantifies the ratio between the sound intensity radiated into that direction and the intensity averaged over all directions.

It should be clear that all of these representations for the directivity pattern are essentially equivalent and have straightforward relationships to each other, and any of them can be used in the context of this disclosure by converting it to the representation that is assumed in the method described above.

The initial position and orientation of a sound source will also typically be available as metadata for the sound source. In dynamic and/or interactive XR scenes, the source position and orientation may vary, but typically they are readily available to the audio renderer.

The position/size/shape information about the portal may also be directly available or readily derivable from scene description metadata or may be derived in some other way as described in more detail below.

As a simple example, consider a situation where an omnidirectional source is positioned exactly in the middle of the (flat) open portal between Spaces 1 and 2 of FIG. 3. In this case, the portal occupies a solid angle of 2π (i.e., a half sphere) with respect to the sound source. Hence, because the source is omnidirectional, we find that half (2π/4π) of the total amount of power radiated by the omnidirectional source propagates directly through the portal, so the direct propagation value we obtain is 0.5.

If instead the sound source has a non-omnidirectional directivity pattern and the orientation of the source is such that the “loudest side” of the source is directed away from the portal, then the direct propagation value will be smaller than 0.5. In the extreme case where the sound source has a directivity pattern that is such that all of the source's energy is radiated to one half sphere, and the source is oriented such that its half-sphere directivity pattern is pointing exactly away from the portal, then the direct propagation value will be 0.

In the more general situation as depicted in FIG. 3, determining the direct propagation value for the source S with respect to the portal between Space 1 and Space 2 requires first the step of determining the projection of (the edges of) the portal geometry on an imaginary unit sphere around the sound source S, taking into account the source's position.

Suppose the projection of the portal covers a solid angle Ωₚₒᵣₜₐₗ on the unit sphere around the source S and that the source S has a normalized directivity pattern D (@) (expressed in terms of power), with @ the space angle, and an orientation R with respect to some reference orientation. Then, the direct propagation value may be determined from integration of the rotated directivity pattern over the solid angle Ωₚₒᵣₜₐₗ, and normalizing by the surface area of the unit sphere 4π:

$$\frac{1}{4 π} {\int }_{{Ω}_{portal}} {D}_{rot , R} ( ω ) d ω ,$$

with D_{rot,R} the directivity pattern D suitably rotated according to the source orientation R.

Note that if the source is omnidirectional, then the above procedure simply reduces to determining the normalized surface area of the projection on the unit sphere.

To determine a direct propagation value based on the segment covered by a projection of the portal on the source directivity pattern, processing based on the scene geometry needs to be performed to determine the projection and its size (area) on the unit sphere.

In one example embodiment, the analysis is done on an encoder device based on the scene geometry and object source positions. The analysis can also be performed by the renderer. In this example embodiment, the portal opening is typically a box with eight vertices and represents, e.g., an opening of a door between two spaces. In cases the portal opening is not a box the portal geometry can be, for example, converted into a box by enclosing the portal geometry with a box.

There are various ways to obtain the portal openings from the scene geometry which can be represented as meshes or voxels. In one example, a content creator provides explicit metadata that indicates the positions of the portals, for example, as a set of vertices. Such portal metadata can then be carried as metadata. In another example, processing on the encoder/renderer device can be used to automatically analyze the portals between acoustic environments. In an example method, each space is enclosed by a geometry such as a box. Whenever there is a portal between spaces, there exists a line of sight between spaces. Such line of sight can be determined, for example, by shooting rays at all possible directions from each space. Whenever a ray shot this way hits another space, it means it travelled through a portal. Combining all ray hits from a first space to a second space will give a rough shape of a projection of a portal between spaces on the surface of the second space. This can be considered as one face of the portal. The starting points of the rays that hit on the surface of the first space will define another face of the portal geometry. The full portal geometry can be obtained by forming an outer hull to combine these two faces.

In one example embodiment, for each object source in the scene, four vectors are aimed from the position of the object source (“objsrc_pos”) at the four vertices of the portal closest to objsrc_pos to generate a geometric shape of the sound emitted from the sound source towards the portal. Four 3 D points are then translated 1 m along each vector and a mesh is constructed using these points as vertices. The area of the formed mesh is divided by the area of a unit sphere (4π). This yields the direct propagation value to be used in the renderer. It is noted that in this example embodiment the directivity pattern is assumed omnidirectional. In some other examples the directivity pattern can be non-omnidirectional and in those examples integration over the directivity pattern is performed as described earlier.

Vertices for the portal opening are denoted as [vpopen0, vpopen1, vpopen2, vpopen3]. These vertices are selected as the corners of the face of the portal, which is close-to parallel to at least portion of the wall of the space where the portal is located, and whose center point is closest to the center of the space. It is noted that if the face is not rectangular, it can be bounded by a rectangle and the bounding rectangle corners can be used as the vertices. Alternatively, if the face is not rectangular then four nearly equidistant points can be selected from the face circumference to be used instead of vertices. In some other examples the face of the portal denoting the opening of the portal from the space can be indicated otherwise, e.g., manually by the content creator. In yet some other examples, the vertices can be selected from a vertical cross-section of the portal in the middle of the portal geometry. In yet some other examples, the vertices can be selected from the face which is the outmost of the portal, so, towards the space to where the power is transferred.

For each vertex, a 3 D vector Vobjsrc_vi, i=0, 1, 2, 3, between objsrc_pos and vpopen0, vpopen1, vpopen2, vpopen3 is formed.

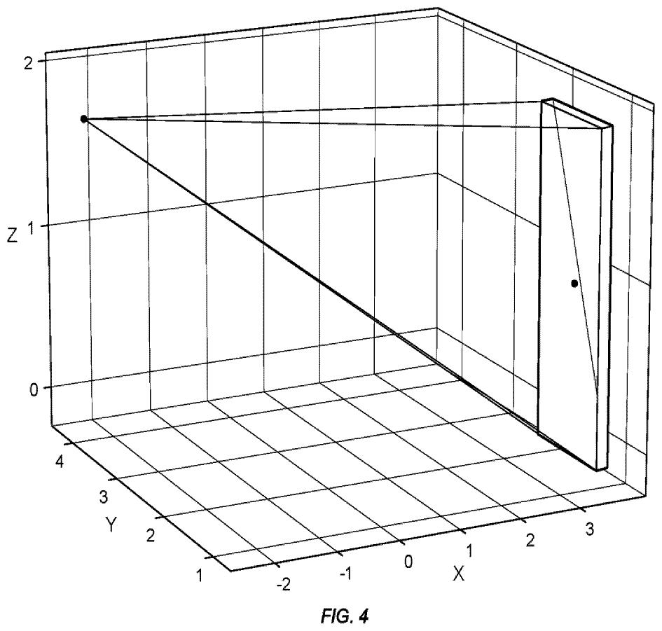

FIG. 4 visualizes [Vobjsrc_v0, Vobjsrc_v1, Vobjsrc_v2, Vobjsrc_v3] towards portal opening vertices [vpopen0, vpopen1, vpopen2, vpopen3], respectively.

To obtain the area from one meter away from the sound source, four 3 D points (P0, P1, P2, P3) are then defined for each vertex [vpopen0, vpopen1, vpopen2, vpopen3] of the portal opening. This is done by translating objsrc_pos along each of the vectors in turn.

When determining the points Pᵢ, i=0, 1, 2, 3 along the vector Vobjsrc_vi towards the vertex vpopeni, the distance d between objsrc_pos and vpopeni is first checked to avoid translating Pᵢ over certain threshold (basically, beyond the point vpopeni). To maintain the shape of the mesh, a value of 0.1 is subtracted from d if plane_distance>d. Otherwise, objsrc_pos is translated by plane_distance (in one example plane_distance=1), as illustrated in the code below:

```
Pi = Point3D(objsrc_pos.x, objsrc_pos.y, objsrc_pos.z)
for i in range(len(portal_opening_geometry.vertices)):
    d = sqrt((Pi.x − Vi.x)²+(Pi.y − Vi.y)²+(Pi.z − Vi.z)²)
    if d < 1:
        Pi.translateAlongVector(Vobjsrc_vi, d−0.1)
    else:
        Pi.translateAlongVector(Vobjsrc_vi, 1)
```

obj_src is translated d amount along each vector and assigned new x,y,z position in 3 D cartesian space, as illustrated in the code below:

```
  def translateAlongVector(self, direction: Vector3D, distance: float):
      new_pos = Point3D.moveTo(self, direction, distance)
      self.x = new_pos.x
      self.y = new_pos.y
      self.z = new_pos.z
  def moveTo(a, b, distance: float):
      if not isinstance(a, Point3D) and not isinstance(b, Point3D):
          raise ValueError(“Only Point3D type is supported”)
      v1 = Vector3D(b.x − a.x, b.y − a.y, b.z − a.z)
      v2 = Point3D(v1.x / v1.length, v1.y / v1.length, v1.z /
v1.length)
      return Point3D(a.x + v2.x * distance, a.y + v2.y * distance, a.z
+ v2.z * distance)
```

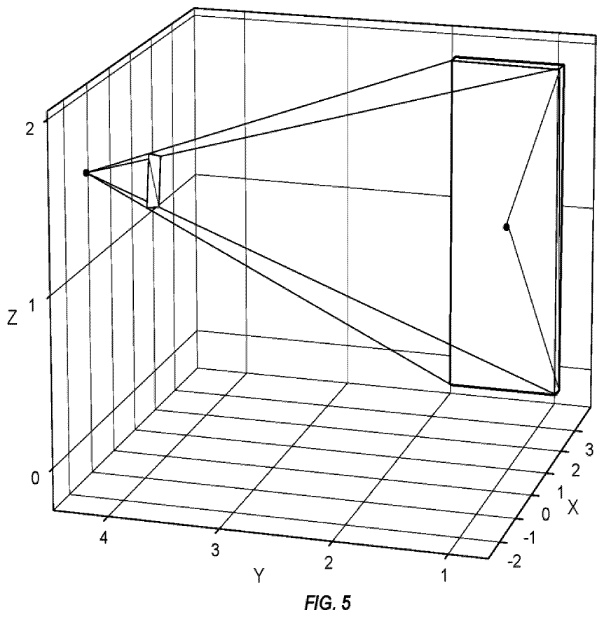

A mesh mesh_{objsrc} is constructed of Pᵢ, i=0,1,2,3 as vertices as visualized in FIG. 5. That is, FIG. 5 illustrates a mesh constructed from Pᵢ, i=0, 1, 2, 3.

The area Amesh_objsrc of the constructed mesh mesh_{objsrc} is divided by the area of a sphere with a diameter of one meter to obtain the direct propagation value for the object source. That is:

$$sphere\_radius = 1$$

$$Asphere = 4 π * {sphere\_radius}^{2}$$

$$directPropagationValue - {A}_{mesh \_ objsrc} / {A}_{sphere}$$

Algorithms for calculating the area of a mesh are readily available in literature and software libraries. For example, the mesh may be triangulated and iterations are performed over the triangles of the mesh. For each triangle, vectors representing the two edges are formed. The area of the triangle is obtained as half of the magnitude of the cross product of the edge vectors. The triangle areas are summed to obtain the full mesh surface area.

The value directPropagation Value is used in the renderer as a coefficient for leaked direct sound power to the connected room via the portal opening. When the above processing for determining the directPropagation Value is run on an encoder device, the following data can be written into payload as defined in RevPortalOpeningData (see below).

### Syntax for Transmitting Direct Propagation Values in Bitstream

The table below illustrates metadata syntax for providing the direct propagation values from the encoder to the renderer.

| | No. of | |
|---|---|---|
| RevPortalOpeningData Syntax | bits | Mnemonic |
| revNumSpaces = getCountOrIndex( ) | var | vlclbf |
| for (i = 0:revNumSpaces-1) | | |
| { | | |
| spaceBsId = getID( ) | var | vlclbf |
| revNumPortalOpenings = getCountOrIndex( ) | var | vlclbf |
| for (i = 0:revNumPortalOpenings-1) | | |
| { | | |
| portalOpeningPositionX | 16 | float |
| portalOpeningPositionY | 16 | float |
| portalOpeningPositionZ | 16 | float |
| } | | |
| } | | |
| revNumObjectSources = getCountOrIndex( ) | var | vlclbf |
| for (i = 0:revNumObjectSources − 1) | | |
| { | | |
| objSrcBsId = getID( ) | var | vlclbf |
| revNumObjsrcSpaces = getCountOrIndex( ) | var | vlclbf |
| for (i = 0: revNumObjsrcSpaces − 1) | | |
| { | | |
| spaceBsId = getID( ) | var | vlclbf |
| revNumObjsrcPortalOpenings = getCountOrIndex( ) | var | vlclbf |
| for (i = 0: revNumObjsrcPortalOpenings − 1) | | |
| { | | |
| directPropagationValue | 16 | float |
| openingConnectionBsId = getID( ) | var | vlclbf |
| } | | |
| } | | |
| } | | |

revNumSpaces is the number of spaces.
revNumPortalOpenings is the number of portal openings per each space.
spaceBsId is the Bitstream identifier of the space.
portalOpeningPositionX is the x element of the portal opening center position in x, y, z space.
portalOpeningPositionY is the y element of the portal opening center position in x, y, z space.
portalOpeningPositionZ is the z element of the portal opening center position in x, y, z space.
obj SrcBsId is the bitstream identifier of the object source.Carried in ScenePayload.
revNumObjsrcSpaces is the number of spaces the analysis is conducted at.
This is larger than one if the objsrc is not located in any space, otherwise equal to 1.
revNumObjsrcPortalOpenings is the number of portal openings in the space being iterated
directPropagation Value is the direct propagation value for each object source towards each portal opening.
openingConnectionBsId is the identifier of a portal between two spaces.

It is noted that in the above example are listed for the space where the audio object is located. One space is sufficient, for example, if the sound source is static. If the object is not static, several such listings and therefore direct propagation values can be listed for more than one possible space and/or objsrc positions. For sources which are not in any space the listing can be provided for all possible spaces and portal openings. Alternatively or in addition to, for object source not in any space the listing could be provided with regard to the closest or otherwise most relevant spaces and/or portal openings.

In the example embodiments described above, the direct propagation value is derived by directly determining the surface area of the projection of the portal on the unit sphere, or, to be precise, an approximation of that projection, and does not include the step of integrating the directivity pattern of the source over the unit-sphere segment covered by the projection of the portal. As explained above, this effectively means that in the method of the example embodiment it is assumed that the source is omnidirectional.

For static sound sources, the example embodiments described above may be extended to be applicable to non-omnidirectional sources by replacing the step of directly determining the surface area of the projection of the portal by the step of integrating the directivity pattern of the source over the unit-sphere segment covered by the projection, taking into account the orientation of the source as described earlier.

Essentially the same procedure as described in the example embodiments above, or its extended version that includes the effect of the directivity pattern, may be carried out in real-time by a renderer, in which case also dynamic changes in source position and orientation may be taken into account in calculating the direct propagation value for a source with respect to a portal. In this case, the direct propagation value will be a dynamic function of source position and orientation.

In another example embodiment for determining the projection and size of the projection of the portal on a unit-sphere around the sound source, a method similar to the method described in clauses 6.5.5 (“DiscoverSESS”) and 6.5.16 (“Homogeneous extent”) of the Working Draft (WD1) of ISO/IEC 23090-4, MPEG-I Immersive Audio [1] may be used. Like the method described above, the method described there uses raytracing to find the projection (and from that the size) of an extended sound source or portal between spaces on a unit-sphere, only there it is a projection on a unit-sphere around the listener instead of around the source. But the same method can, with appropriate adaptations, be applied to find the projection and size of the projection of a portal with respect to a unit-sphere around a sound source.

### Rendering of First-Order Reverberation in the Connected Space

Once the direct propagation value that quantifies the normalized amount of radiated source power that is propagated directly from source S in Space 2 through the portal to the connected Space 1 has been determined, this information can be used to generate and render reverberation in Space 1 with a level that is consistent with this amount of power.

The principle here is to generate reverberation in Space 1 corresponding to a notional (a.k.a., “imaginary”) omnidirectional sound source positioned at an arbitrary position within Space 1, having a source power equal to the amount of direct sound source power that is entering Space 1 through the portal.

It will now be explained how this can be done by a renderer.

The power P of an omnidirectional point sound source radiating spherical sound waves is proportional to the square of the direct sound pressure p of the source:

$${p}^{2} = \frac{{ρ}_{0} c}{4 π {r}^{2}} P ,$$

with r the distance from the source and ρ₀ and c the mass density of and speed of sound in air, respectively.

Comparing acoustical (physics) and audio signal processing domains, the rms acoustic sound pressure p is proportional to the linear rms signal level of the audio source's audio input signal, while the acoustic source power P is proportional to the square of this rms signal level of the input audio signal.

Hence, if we denote the normalized amount of source power that enters Space 1 directly through the portal, i.e., the direct propagation value, by X, then it follows from the above that the audio signal for the notional omnidirectional source that is used to generate the reverberation in Space 1 is the audio signal corresponding to source S scaled by a linear gain of sqrt(X). That is, if we denote the signals of the sound source S in Space 2 and the notional sound source in Space 1 by s2 and s1, respectively, then: s1=sqrt(X)*s2.

Using s1 as an input signal, the reverberation for Space 1 can be generated according to the provided reverberation characteristics of Space 1, such as, for example, reverberation time, reverberation energy ratio, etc.

In the above, it was assumed that the audio signal s2 of source S includes all factors that affect the direct sound level of the source when it is rendered other than the directivity pattern and the distance to the source. Examples of such factors are a source gain (“volume control”) that may be associated with the source, a so-called “reference distance” that may specify a distance from the source where its distance attenuation should be normalized at 1 (0 dB) or muting the source S which is equivalent to applying a source gain equal to zero. If this is not the case, i.e., if the source signal s2 associated with source S is a “raw” input signal to which direct sound level-affecting factors such as an associated source gain, or reference distance, or muting of the source are applied when rendering the source, then these factors should also be applied to the signal s2 in the procedure above, i.e., if the combined effect of the direct sound level-affecting factors is a direct sound gain G, then the equation above may be modified as: s1=sqrt(X)*G*s2 (G may be equal to 1).

### Rendering of First-Order Reverberation for all Sources in all Connected Spaces

In a practical audio scene, there can be several spaces connected by portals. Therefore the method needs to iterate over all sound sources S to determine whether it should be input to the reverberation for Space 1. This can be done as follows:
determine the space where source S is located;
if S is located within Space 1, render reverberation for source S according to the reverberation characteristics for Space 1;
if S is not located within Space 1 but within Space 2, determine whether there is a portal from Space 2 to Space 1, and
if there is such a portal, determine the direct propagation value for source S with respect to the portal from Space 2 to Space 1 and render the reverberation for source S using the notional (a.k.a., imaginary) sound source in Space 1 as described above.

### Occlusion Detection and Handling

The direct propagation value for a source propagating through a portal can optionally be ramped down if the source is not “visible”, i.e., has no direct line of sight through the portal. This can be the result of geometrical features of the space (e.g., a wall that is between the source S and the portal), of objects (e.g., interactive objects) that may move around and block (e.g., temporarily block) the direct line of sight between the source and the portal, or changes in the state of the portal itself (e.g., an open door between two spaces that is suddenly closed). Such an occlusion detection can be performed, for example, by shooting one or more rays from the position of the portal towards the sound source. If one or more rays hit the sound source then it can be determined that the source is visible and the direct propagation value does not need to be ramped down. If, however, no rays hit the sound source then it can be determined that the source is not visible and the direct propagation value can be ramped down.

When a sound source becomes visible or stops from being visible, optionally further direct propagation value smoothing can be applied to prevent abrupt sound level transition. Such direct propagation value smoothing can be performed by gradually increasing the direct propagation value (during source becoming visible) or gradually decreasing the value (during source becoming not visible). Ramping of the value can be done, for example, by increasing or decreasing the value by a predetermined value (such as 0.05) in each audio frame until the desired value is reached.

It is noted that the above cross fading can be equivalently performed for the direct propagation value or the square root (“sqrt”) of it which is the gain value applied on the audio signal.

In another example embodiment for determining the amount of occlusion of a portal with respect to a sound source, a method similar to the method described in clause 6.5.6 (“Occlusion”) of the Working Draft (WD1) of ISO/IEC 23090-4, MPEG-I Immersive Audio [1] may be used. The method described there uses raytracing to find the amount of occlusion for the direct sound path between a source and a listener, by casting rays from the listener position towards an extended sound source. The same method can, with appropriate adaptations, be applied to find the amount of occlusion of a portal with respect to a sound source.

Portals that are not Fully Transparent

In the above, it has been assumed for simplicity that the portal between two spaces is fully acoustically transparent, i.e., it is fully open. Examples are open doors, windows or open portals in general.

However, the same concepts and principles also apply to portals that are not fully open but are only partly transmissive, i.e., general interfaces between spaces through which sound energy can be propagated. The only modification that is needed for this generalization of the concept is that the propagated power, and thus the direct propagation value, should be scaled with a number that is equal to the fraction of energy that is transmitted by the portal compared to a fully open portal of the same geometrical size.

For example, if an interface between two spaces, e.g., a thin wall, is made of such material that it transmits 30% of the power that impinges on it to the neighboring space, then the direct propagation value for a source with respect to that interface would be 30% of the value calculated with an assumption of the interface being an open portal.

In the general case, in which the energy transmission coefficient may vary over the portal, the scaling would be obtained by an integration of the energy transmission coefficient over the portal area and normalizing by the geometrical area of the portal.

Note also that the transmission coefficient of a portal may be frequency-dependent, so that also the direct propagation value may be frequency-dependent. This would be reflected in, e.g., relatively more low-frequency reverberation being generated in the connected space than high-frequency reverberation.

### Cascading of Connected Spaces

If more than two spaces are connected to each other in a cascade via multiple portals, then the method described above can be extended. In this case, the main challenge is to determine the amount or portion of sound source power that propagates directly through multiple portals, rather than through a single portal as has been the case in the descriptions above.

This can be done by projecting the portals between the consecutively connected spaces on the unit sphere around the sound source and determining the overlapping parts of the projections. These overlapping parts represent angular regions where there is direct “line of sight” between the source and the “furthest” connected space.

In the above bitstream description, the portals can be defined with the help of the starting and ending Spaces: a portal connecting Spaces 1, 2, and 3 so that there is a pathway from Space 1 through Space 2 into Space 3 can index the Spaces 1 and 3.

Pre-Calculating Direct Propagation Values for any Source Position within a Space

In another approach, an interpolated grid for pre-calculated values can be used to approximate the direct propagation value for the object source based on its position.

Each space has a bounding geometry (“spacebounding”) which defines the extent of the Space. The object source positions are interpolated from x and y planar extents of spacebounding by resolution defined by interpResolution. In this example, a value of 0.5 is used as illustrated in the code below.

```
    interpResolution = 0.5
    v0, v1, v2, v3, v4, v5, v6, v7 =
space_bounding_geometry_trimesh.vertices
    points = [ ]
    for vertex in space_bounding_geometry_trimesh.vertices:
        points.append(Point3D(vertex[0], vertex[1], vertex[2]))
    v0, v1, v2, v3, v4, v5, v6, v7 = points
    width, length, depth = [v0.distanceTo(v4), v0.distanceTo(v2),
v0.distanceTo(v1)]
    n_w_interp = int (width / interpResolution)
    n_1_interp = int (length / interpResolution)
    objsrc_positions = [ ]
    x_row = [ ]
    for i in range (n_w_interp):
      x = i * interpResolution
      x_row.append([v0.x + x, v0.y, v0.z])
    for i in range(n_1_interp):
      y = i * interpResolution
      for j in range (n_w_interp):
          objsrc_positions.append([x_row[j][0], x_row[j][1] + y,
x_row[ j][2]])
    return objsrc_positions
```

The method distanceTo is further described as (pow(x, y) denotes x to the power of y).

```
def distanceTo(self, another):
    if not isinstance(another, Point3D):
        raise ValueError(“Only Point3D type is supported)
    return sqrt(pow(self.x − another.x, 2) + pow(self.y −
another.y, 2) + pow(self.z − another.z, 2))
```

Interpolated object source positions are then used and object source-portal opening analysis is conducted for each position using the procedure above. A grid of possible object source positions with corresponding direct propagation values is obtained.

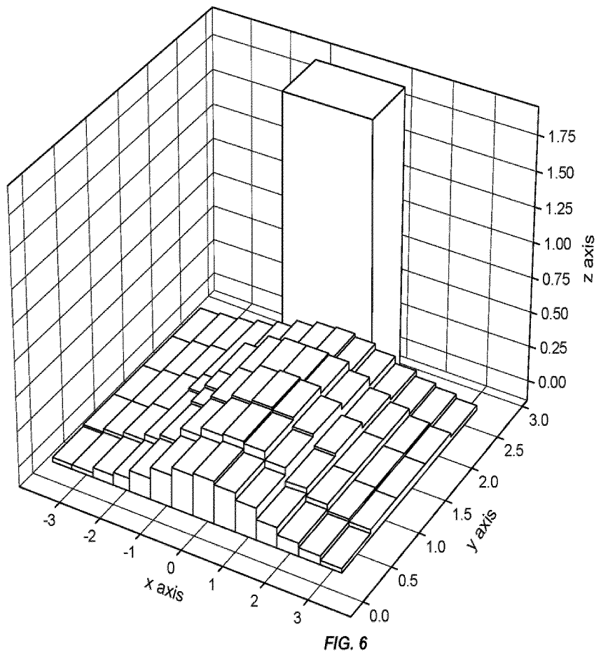

FIG. 6 illustrates the concept of an interpolated direct propagation value grid for possible object source positions. As depicted in FIG. 6 all possible x, y positions interpolated with interpResolution=0.5 are assigned a direct propagation value, which is dependent on the angle and distance. This information can be used to approximate the behavior of the direct propagation value if an object source is moving around in the Space.

In some examples of the implementation, the direct propagation values within a space for different possible object positions are modeled with a function in two variables. An example is using a function of two variables (x, y), such as, for example a polynomial function of two variables. The coefficients of such a polynomial can be signaled in a bitstream to a renderer device and can be used there for obtaining the direct propagation value for any source position within a space.

### Propagation of Reverberation Through a Portal and Generation of “Second-Order” Reverberation

The embodiments described above focused on the reverberation that is generated in a first space as a result of direct sound from a source in a second space that propagates from the second space to the first space through a portal. However, further challenges are found in the propagation of reverberation from one space to the other through the portal, and the subsequent generation of second-order reverberation in response to the propagated reverberation.

Referring back to the scenario of FIG. 3, these further challenges can be summarized as: (1) realistic rendering in Space 1 of Space 2 reverberation that propagates through the portal into Space 1, or vice-versa, realistic rendering in Space 2 of Space 1 reverberation propagating back to Space 2 via the portal (this is essentially the same problem), and (2) Generation and realistic rendering in Space 1 of “second-order” reverberation that is generated in Space 1 in response to the Space 2 reverberation that propagates through the portal.

As with the propagation of direct sound through the portal, the key component in solving the problem of propagation of reverberation through a portal, and subsequent generation of second-order reverberation, is determining the amount of power (in this case: diffuse field power) that is transferred through the portal.

It can be shown that the amount of diffuse power P_{1->2} that is transferred from a first space to a second space through a portal has the following relationship with the diffuse sound pressure p₁ in the first space:

$${P}_{1 \to 2} = ( \frac{{S}_{portal}}{4 {ρ}_{0} c} ) {p}_{1}^{2} ,$$

where Sₚₒᵣₜₐₗ is the size of the portal in m². If the portal is fully open, then Sₚₒᵣₜₐₗ is equal to the geometrical size of the portal, otherwise it is equal to the size of a fully open portal representing the same total amount of sound transmission, ρ₀ is the mass density in air, and c is the speed of sound in air. The size of the portal Sₚₒᵣₜₐₗ may be obtained directly from scene description metadata or derived from it. For example, the size may be derived from the vertices that describe the portal or from a mesh that is constructed from the vertices, as explained in detail above. As also described above, raytracing techniques may be used to find the edges of the portal from which its size can be determined.

Hence, if the level of the reverberation in the first space and (equivalent) size of the portal are known, then the amount of diffuse power that is transferred to the second space can be determined.

From this amount of transferred diffuse power it is possible to generate second-order reverberation in the second space similar to how was described in the paragraph “Rendering of first-order reverberation in the connected space” above. I.e.: the transferred diffuse power P_{1->2} is assigned to a notional point source located at an arbitrary position in the second space.

It can be shown that this leads to a relationship between the diffuse pressure p₁ in the first space and the direct sound pressure p_{2,1m} at 1 m from the notional source in the second space given by:

$${p}_{2 , 1 m}^{2} = ( \frac{{S}_{portal}}{16 π} ) {p}_{1}^{2} .$$

If the reverberation strength of the second space is expressed as a reverberant-to-direct energy ratio (or its inverse) at 1 m from an omnidirectional point source, then this equation provides all information that is needed to generate second-order reverberation of the correct level in the second space. Specifically, if the reverberant-to-direct energy ratio for the second space is denoted RDR₂, then the desired pressure of the diffuse reverberation in the second space may be given by:

$${p}_{2 , diffuse}^{2} = R D {R}_{2} * ( \frac{{S}_{portal}}{16 π} ) {p}_{1}^{2} .$$

In one embodiment, the conceptual process described above may be implemented by the following steps:
(1) Deriving one or more reverberation input signals for generating second-order reverberation in the second space;
(2) Obtaining a size of a portal through which sound is transmitted between the first space and the second space;
(3) Determining a reverberation scaling factor that models the transmission of reverberant sound from the first space to the second space using the portal size; and
(4) Rendering a reverberation signal in the second space, using the reverberation input signal(s), and the reverberation scaling factor. In some embodiments, the reverberation signal in the second space is rendered also using information indicating the strength of the reverberation in the first space.

More details and additional embodiments for generating and rendering second-order reverberation are described in provisional application U.S. 63/429,643, relevant portions of which are included in the section “Additional Disclosure.”

The above described generating and rendering of second-order reverberation in response to reverberation that is propagated through a portal from a first reverberant space into a second reverberant space. However, if the second space is free-field, i.e., has no reverberation of its own, then the reverberation that propagates from the first space to the second space should still be heard as reverberation coming from the portal in the second space. An example of this is when a listener is standing in a large open outdoor space in front of the open doors of a large cathedral in which music is being played.

In this case, the portal acts as an extended sound “source”, which has a source power equal to the transferred diffuse power P_{1->2} as described above. The steps in determining the correct power for this portal source are therefore essentially the same as for the second-order reverberation described above, but the main difference now is that the portal is not a (notional) omnidirectional point source, but an extended source that effectively radiates all of its source power P_{1->2} into a half-space only (namely, the second space).

In one embodiment, the radiation from the portal may be modelled as half-spherical (i.e., radiating spherical waves only into the second space), in which case the relationship between the diffuse pressure p₁ in the first space and the pressure at 1 m from the portal source, p_{2,1m}, may be given by:

$${p}_{2 , 1 m}^{2} = ( \frac{{S}_{po rtal}}{8 π} ) {p}_{1}^{2} , or ,$$

$${p}_{2 , 1 m}^{2} = min \{ ( \frac{{S}_{portal}}{8 π} ) , 0.5 \} {p}_{1}^{2} ,$$

with Sₚₒᵣₜₐₗ as defined earlier.

In another embodiment, the pressure p₂ at a specific position in the second space may be determined from the diffuse pressure p₁ in the first space, as:

$${p}_{2}^{2} = ( \frac{{Ω}_{portal}}{4 π} ) {p}_{1}^{2} ,$$

where Ωₚₒᵣₜₐₗ is the solid angle that the portal represents as “seen” from the specific position in the second space, i.e., the angular size of the projection of the portal on a sphere around the specific position.

In yet other embodiments, specific spatial radiation models for the portal source may be used to determine the desired relationship between the strength of the reverberation in the first space (proportional to the diffuse pressure p₁) and the rendered sound level in the second space.

While the rendering of propagated reverb was described above for the example where the second space is free-field, i.e., non-reverberant, the same applies when the second space is reverberant, i.e., also in that case the reverberation propagating from the first space into the second space may be rendered as a “portal source” as described above, in addition to the generation and rendering of “second-order” reverberation.

Additional details and additional embodiments for rendering propagated reverberation from a portal are described in provisional application U.S. 63/429,643, relevant portions of which are included in the section “Additional Disclosure.”

### Architecture

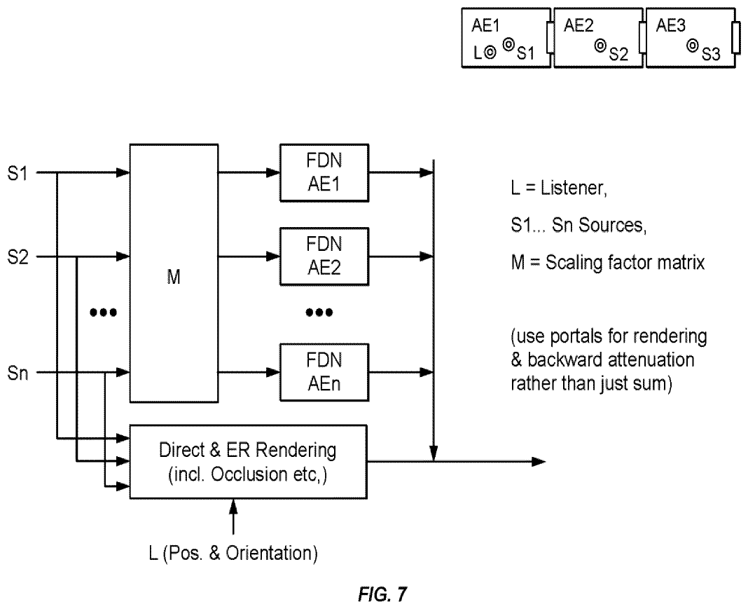

FIG. 7 illustrates an efficient architecture for use in an audio renderer implementing some of the embodiments described above.

N audio sources S1. . . Sn are located in a number of acoustic environments (e.g., rooms) AE1, AE2, AE3, . . . . AEn. For some AEs there is an acoustical connection (i.e., portal) that acoustically connects the AE to one or more other AEs.

Each AE has an associated Feedback Delay Network (FDN) (or other kind of reverberator) that models the late reverberation characteristics of this AE, considering relevant parameters like frequency dependent Reverberation Time (RT60), reverberation energy ratio, and pre-delay.

For all sources, the rendering of their direct signal part and their early reflections is carried out using well-known methods, and is based on the sources' position/orientation and on the position/orientation of the listener.

For rendering of the late reverberation part of these sources, the source signals are fed into a matrix of scaling factors that weight each contribution from a particular source into a particular target AE/FDN and then sums up the contributions into this AE's FDN. The scaling factors of the matrix are the direct propagation values as described above that determine how much direct sound energy propagates into the adjacent rooms/AEs to excite late reverberation in these rooms/AEs. The factors may also include the coupling factors (reverberation scaling factors as described above) that reflect how much of the late reverb energy from the spaces/rooms/AEs propagates back into the listener's location. Reverberation scaling factors/coupling factors expressed in terms of energy have to be converted to amplitude factors using a square root function in order to result in linear signal scaling factors.

The summed direct source contributions are then fed into each of the AEs/FDNs. The output of the AEs/FDNs may be rendered using virtual loudspeakers, if so desired.

Finally, all AE/FDN contributions are summed up together with the rendered direct sound and early reflection sound to form the fully rendered output.

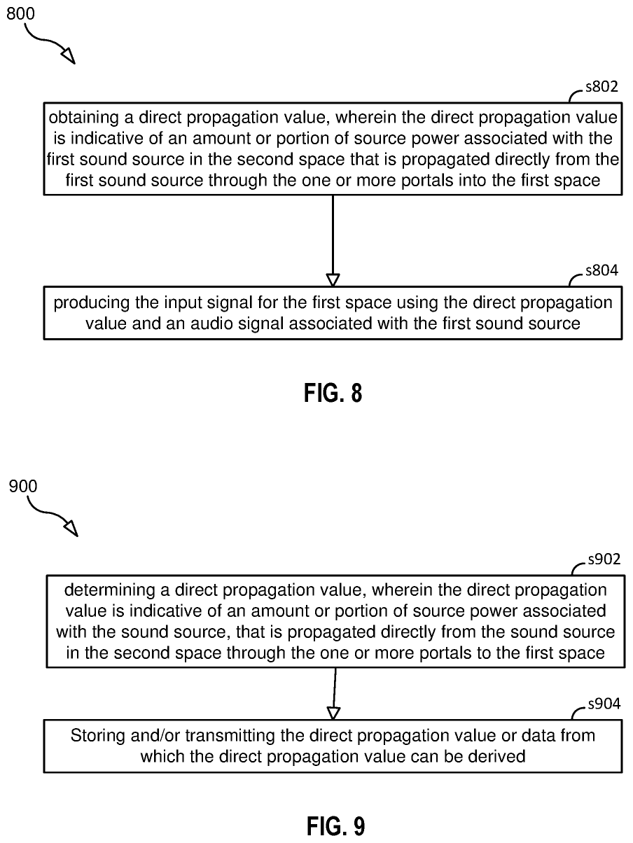

FIG. 8 is a flowchart illustrating a process 800 for producing an input signal for a first space (e.g. space 301) of an XR scene (e.g. XR scene 390) based on a first sound source (e.g., sound source 391) in a second space (e.g. space 302) of the XR scene, wherein the first space is connected, either directly or indirectly, to the second space via one or more portals including at least a first portal (e.g., portal 300). Process 800 may begin in step s802. Step s802 comprises obtaining a direct propagation value, wherein the direct propagation value is indicative of an amount or portion of source power associated with the first sound source in the second space that is propagated directly from the first sound source through the one or more portals into the first space. Step s804 comprises producing the input signal for the first space using the direct propagation value and an audio signal associated with the first sound source.

In some embodiments, the method further comprises using the input signal for the first space to generate a reverberation signal for the first space.

In some embodiments, the reverberation signal for the first space is generated using reverberation control information associated with the first space.

In some embodiments, the reverberation control information comprises a reverberation level or reverberation energy ratio parameter associated with the first space.

In some embodiments, the method further comprises rendering the reverberation signal.

In some embodiments, s1=sqrt(X)*G*s2, where s1 is the input signal for the first space, X is the direct propagation value, G is a gain factor, and s2 is the audio signal associated with the first sound source.

In some embodiments, the method further comprises receiving metadata associated with the XR scene, the metadata comprises the direct propagation value or data from which the direct propagation value can be derived, and obtaining the direct propagation value comprises obtaining the direct propagation value from the metadata or obtaining the direct propagation value using the data.

In some embodiments, the metadata comprises coefficients of a polynomial, and obtaining the direct propagation value comprises obtaining the direct propagation value using the polynomial coefficients.

In some embodiments, obtaining the direct propagation value comprises deriving the direct propagation value using information indicating a position of the first sound source in the second space and one or more of: i) information indicating a position of the first portal, ii) information indicating a size of the first portal, and iii) information indicating a shape of the first portal.

In some embodiments, one or more of: information indicating a directivity pattern of the first sound source or information indicating an orientation of the first sound source is also used to derive the direct propagation value.

In some embodiments, information indicating a directivity pattern of the first sound source and/or information indicating an orientation of the first sound source is/are also used to derive the direct propagation value.

In some embodiments, the process further comprising receiving metadata associated with the XR scene, the metadata comprises portal position information indicating the positions of the one or more portals, and obtaining the direct propagation value comprises deriving the direct propagation value using the portal position information.

In some embodiments, for each portal, the metadata comprises information indicating a geometry of the portal.

In some embodiments, the first portal is associated with a transmission coefficient, and the direct propagation value is obtained using the transmission coefficient.

In some embodiments, obtaining the direct propagation value comprises

obtaining the direct propagation value using an interpolated grid of pre-calculated values and information indicating a position of the first sound source.

In some embodiments, obtaining the direct propagation value comprises: forming a mesh representing the first portal; determining an area of the mesh; and using the area of the mesh to calculate the direct propagation value.

In some embodiments, obtaining the direct propagation value comprises: projecting edges of the first portal on a sphere around the sound source; determining a surface area of a sphere segment covered by the projection of the first portal to obtain a value; and normalizing the obtained value by the surface area of the sphere, wherein the direct propagation value is the normalized value.

In some embodiments, obtaining the direct propagation value comprises: projecting edges of the first portal on a sphere around the sound source; integrating a directivity pattern associated with the sound source over a sphere segment covered by the projection of the first portal to obtain a value; and normalizing the obtained value by the surface area of the sphere, wherein the direct propagation value is the normalized value.

In some embodiments, the sphere is a unit sphere and the surface area of the unit sphere is 4.

In some embodiments, the first portal has eight vertices.

In some embodiments, a geometry of the first portal is converted into a box by enclosing the portal geometry with a box.

In some embodiments, the process further comprises: using the input signal for the first space to generate a first reverberation signal for the first space; obtaining a first scaling factor, wherein the first scaling factor is indicative of an amount or portion of reverberant energy associated with the first reverberation signal that is propagated through the one or more portals into the second space; producing a second input signal for the second space using the first scaling factor and the first reverberation signal; and using the second input signal for the second space to generate a second reverberation signal for the second space.

FIG. 9 is a flowchart illustrating a process 900 for enabling the rendering of reverberation in a first space (e.g., space 301) of an XR scene (e.g. XR scene 390) connected, either directly or indirectly, to a second space (e.g., space 302) of the XR scene via one or more portals including at least a first portal (e.g., portal 300), wherein a sound source (e.g., sound source 391) is present in the second space. Process 900 may begin in step s902. Step s902 comprises determining a direct propagation value, wherein the direct propagation value is indicative of an amount or portion of source power associated with the sound source, that is propagated directly from the sound source in the second space through the one or more portals to the first space. Step s904 comprises storing and/or transmitting the direct propagation value or data from which the direct propagation value can be derived.

In some embodiments, the process further comprises transmitting metadata to an audio renderer, wherein the metadata comprises the direct propagation value or the data from which the direct propagation value can be derived.

In some embodiments, determining the direct propagation value comprises: forming a mesh representing the first portal; determining an area of the mesh; and using the area of the mesh to calculate the direct propagation value.

In some embodiments, determining the direct propagation value comprises: projecting edges of the first portal on a sphere around the sound source; determining a surface area of a sphere segment covered by the projection of the first portal to obtain a value; and normalizing the obtained value by the surface area of the sphere, wherein the direct propagation value is the normalized value.

In some embodiments, determining the direct propagation value comprises: projecting edges of the first portal on a sphere around the sound source; integrating a directivity pattern associated with the sound source over a sphere segment covered by the projection of the first portal to obtain a value; and normalizing the obtained value by the surface area of the sphere, wherein the direct propagation value is the normalized value. In some embodiments, the sphere is a unit sphere and the surface area of the unit sphere is 4 x.

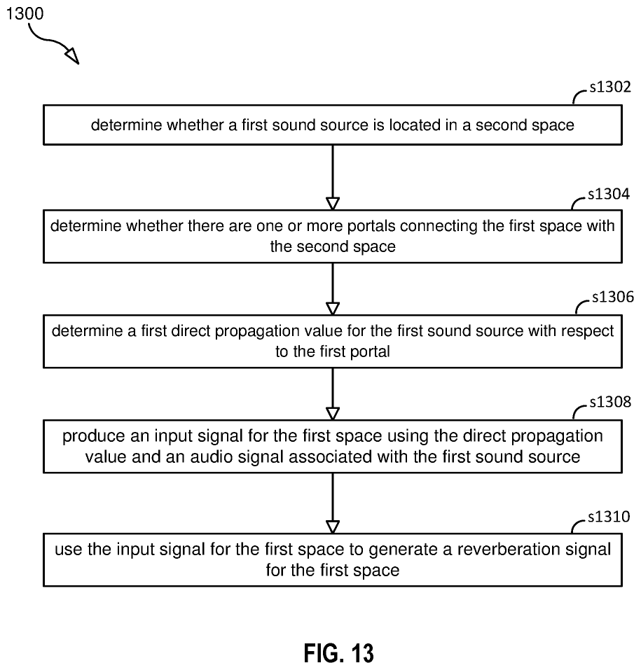

FIG. 13 is a flowchart illustrating a process 1300 for rendering of first-order reverberation in a first space (e.g., space 301) of an XR scene (e.g. XR scene 390). Process 1300 may begin in step s1302. Step s1302 comprises determining whether a first sound source (e.g., sound source 391) is located in a second space (e.g., space 302). Step s1304 comprises determining whether there are one or more portals connecting the first space with the second space. Step s1306 comprises, as a result of determining that a first sound source is located in the second space and that there is at least a first portal (e.g., portal 300) connecting the first space with the second space, determining a first direct propagation value for the first sound source with respect to the first portal. Step s1308 comprises producing an input signal for the first space using the direct propagation value and an audio signal associated with the first sound source. Step s1310 comprises using the input signal for the first space to generate a reverberation signal for the first space.

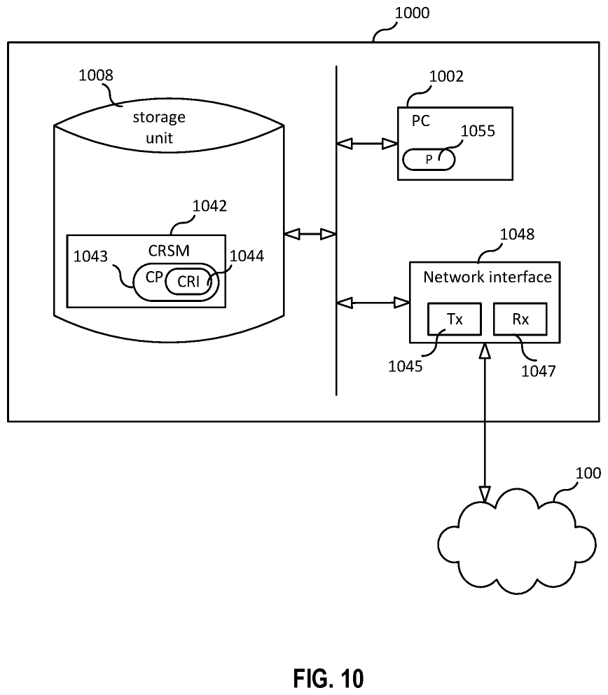

FIG. 10 is a block diagram of an apparatus 1000, according to some embodiments, for performing the methods disclosed herein. That is, apparatus 1000 may implement audio renderer 151 or encoder 169. Apparatus 1000 may be referred to as an audio rendering apparatus when apparatus 1000 implements an audio renderer and apparatus 1000 may be referred to as an encoding apparatus when apparatus 1000 implements an encoder. As shown in FIG. 10, apparatus 1000 may comprise: processing circuitry (PC) 1002, which may include one or more processors (P) 1055 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1000 may be a distributed computing apparatus); at least one network interface 1048 comprising a transmitter (Tx) 1045 and a receiver (Rx) 1047 for enabling apparatus 1000 to transmit data to and receive data from other nodes connected to a network 100 (e.g., an Internet Protocol (IP) network) to which network interface 1048 is connected (directly or indirectly) (e.g., network interface 1048 may be wirelessly connected to the network 100, in which case network interface 1048 is connected to an antenna arrangement); and a storage unit (a.k.a., “data storage system”) 1008, which may include one or more non-volatile storage devices and/or one or more volatile storage devices. In embodiments where PC 1002 includes a programmable processor, a computer program product (CPP) 1041 may be provided. CPP 1041 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes apparatus 1000 to perform steps described herein (e.g., steps described herein with reference to the flow charts). In other embodiments, apparatus 1000 may be configured to perform steps described herein without the need for code. That is, for example, PC 1002 may consist merely of one or more ASICs. Hence, the features of the embodiments described herein may be implemented in hardware and/or software.

### Summary of Additional Embodiments

A1. A method for producing an input signal for a first space, Space 1, of an XR scene based on a sound source, S, in a second space, Space 2, of the XR scene, wherein Space 1 is connected to Space 2 via a portal, the method comprising: obtaining a direct propagation value, X, wherein the direct propagation value quantifies an estimate of the amount (e.g., a normalized amount) of radiated source power that is propagated directly from the sound source S in Space 2 through the portal to the connected Space 1; and producing the input signal for space 1, s1, using X and a signal associated with S, s2.

A2. The method of embodiment A1, further comprising using s1 to generate a reverberation signal for space 1.

A3. The method of embodiment A2, further comprising rendering the reverberation signal.

A4. The method of any one of embodiments A1-A3, wherein s1=sqrt(X)*G*s2, where G is a gain factor (e.g., G≥0).

A5. The method of any one of embodiments A1-A4, wherein the method further comprises receiving metadata associated with the XR scene, the metadata comprises the direct propagation value, and the direct propagation value is obtained from the metadata.

B1. A method for enabling the rendering of reverberation in a first space, Space 1, of an XR scene connected to a second space, Space 2, of the XR scene via a portal, wherein a sound source, S, is present in Space 2, the method comprising: determining a direct propagation value, X, wherein the direct propagation value quantifies an estimate of the amount (e.g., a normalized amount) of radiated source power that is propagated directly from sound source S in Space 2 through the portal to the connected Space 1; and storing and/or transmitting the direct propagation value.

B2. The method of embodiment B1, further comprising transmitting metadata to an audio renderer, wherein the metadata comprises the direction propagation value.

B3. The method of embodiment B1 or B2, wherein determining X comprises: forming a mesh; determining the area of the mesh; and using the area of the mesh to calculate X.

B4. The method of embodiment B1 or B2, wherein determining X comprises: projecting edges of the portal on a unit sphere around the sound source; integrating a directivity pattern of the sound source over a spherical segment covered by the projection of the portal to obtain a value; and normalizing the obtained value by the surface of the unit sphere (4π), wherein X is the normalized value.

C1. A computer program comprising instructions which when executed by processing circuitry of an apparatus 1000 causes the apparatus to perform the method of any one of the above embodiments.

C2. A carrier containing the computer program of embodiment C1, wherein the carrier is one of an electronic signal, an optical signal, a radio signal, and a computer readable storage medium.

D1. An apparatus that is configured to perform the method of any one of the above embodiments.

D2. The apparatus of embodiment D1, wherein the apparatus comprises memory and processing circuitry coupled to the memory.

### Additional Disclosure

As noted above, this disclosure provides embodiments for producing a plausible rendering of reverberation in complex XR scenes with connected acoustic spaces. For instance, this disclosure provides means for determining an acoustic coupling factor that is indicative of the amount of reverberation that propagates from a first space (“acoustic environment”) into a second space through a portal (e.g., an opening, or a partly transmitting surface) connecting the two spaces. In one embodiment, the determined acoustic coupling factor is determined using information indicating a size of the portal.

In some embodiments, based on the acoustic coupling factor, an appropriate signal level is set for rendering one or more audio signals into the second space, where the one or more audio signals are derived from one or more reverberation signals corresponding to the first space. For example, in some embodiments, the determined acoustic coupling factor is used to derive a scaling factor, where the scaling factor is used to scale one or more audio signals derived from a set of one or more audio signals representing the reverberation in the first space. In some embodiments, the scaling factor is further determined based on an amplitude, power, or energy of a total reverberation signal received at a position in the first space.

In some embodiments, the signal level for the signal rendered into the second space is determined based on one or more acoustic parameters for the first space, more specifically a reverberation level parameter or reverberation energy ratio parameter associated with the first space.

### Theoretical Framework

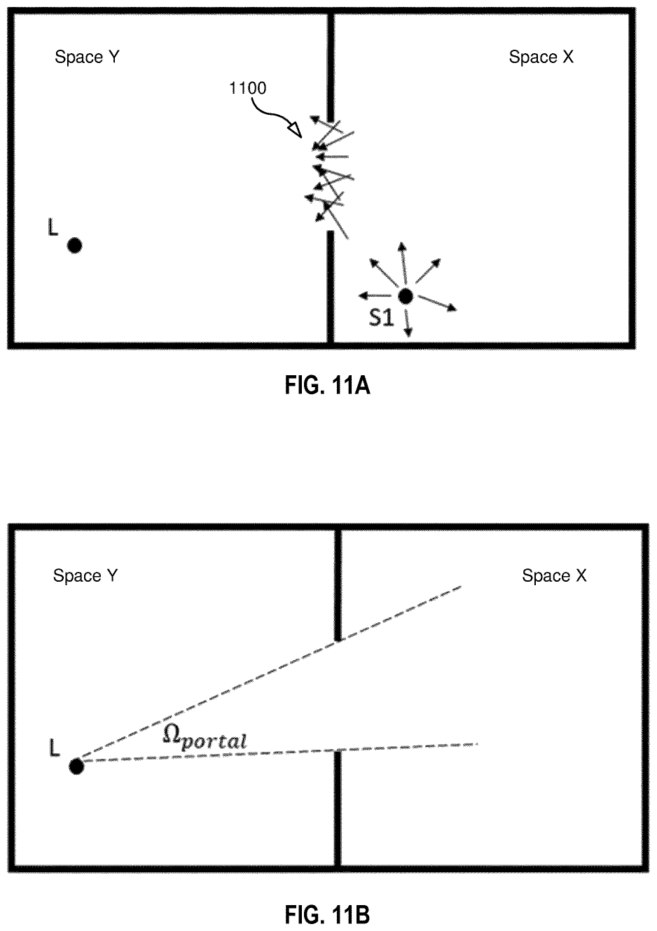

FIG. 11A shows a scene (real-life or VR) that consists of two spaces: Space X and Space Y. The spaces are connected to each other via a portal 1100 (which may alternatively be referred to as an “opening”, “aperture”, “interface”, or similar). A sound source S1 is positioned somewhere in Space X. Sound source S1 generates a reverberant sound field in Space X.

The portal represents an interface between Space X and Space Y, through which some portion of reverberant sound energy may be exchanged between the two spaces. The portal has an “acoustic” size (a.k.a., “associated” size) (area) of Sₚₒᵣₜₐₗ m². In case the portal is an acoustically fully transparent opening, e.g., an open door or window, then the acoustic size Sₚₒᵣₜₐₗ of the portal is simply equal to the portal's geometric size (e.g., the geometrical area of the portal). More generally, if the portal is not fully open but is only partly acoustically transparent (e.g., a thin wall or thick curtain separating two spaces), the acoustic size Sₚₒᵣₜₐₗ of the portal is the equivalent size of a fully transparent opening representing the same amount of energy “leakage”. In other words, if the portal is not fully acoustically transparent, the portal's acoustic size Sₚₒᵣₜₐₗ will be smaller than its geometric size. In the following, whenever there is mention of the “size” or “area” of the portal, it is the “acoustic” size that is meant, unless explicitly stated otherwise.

Part of the reverberant sound energy that is generated by the sound source in Space X propagates through the portal into Space Y, where a listener L positioned in Space Y hears the reverberation coming from Space X through the portal.

To determine the level of the Space X reverberation that is perceived by a listener L in Space Y, the amount of reverberant sound energy transferred from Space X to Space Y through the portal needs to be determined.

For simplicity, Space Y is first considered a “free field”, meaning that it is either a very large open (e.g., outdoor) space, or a space with very high acoustic absorption, such that no reverberant energy is propagated back from Space Y into Space X, so it is a one-way problem.

Assuming a steady-state diffuse sound field in Space X, meaning that the amount of sound energy leaving Space X per unit of time through absorption and portals to connecting spaces is equal to the power of the sound source S1 in Space X, it can be shown that the so-called average reverberant energy density in Space X due to the source S1 in Space X, E_{1,1}, is equal to:

$${E}_{1 , 1} = ( 4 / c ) * ( {P}_{1} / {A}_{1 , tot} ) , \qquad ( 1 )$$

where P₁ is the acoustic power (expressed in Watts) of the sound source S1 in Space X, A_{1,tot} is the total absorption in Space X including the amount of absorption represented by the portal, expressed in terms of equivalent absorptive area (m²), and c is the speed of sound in air (in m/s).

A_{1,tot} can be further specified in terms of the amount of absorption A_{1,0} in Space X excluding the portal, and the size of the portal Sₚₒᵣₜₐₗ (in m²), as:

$${A}_{1 , tot} = {A}_{1 , 0} + {S}_{portal} . \qquad ( 2 )$$

It can further be shown that under diffuse steady state conditions, the power P_{1->2} that is transferred from Space X to Space Y through the portal, expressed in Watts, is in general equal to:

$${P}_{1 - > 2} = ( c / 4 ) * {E}_{1 , 1} * {S}_{portal} ( W ) . \qquad ( 3 )$$

Combining equations 1, 2 and 3, we obtain for the power that is transferred from Space X to Space Y through the portal:

$${P}_{1 - > 2} = ( {S}_{portal} / {A}_{1 , tot} ) * {P}_{1} = ( {S}_{portal} / ( {A}_{1 , 0} + {S}_{portal} ) ) * {P}_{1} ( W ) . \qquad ( 4 )$$

The factor (Sₚₒᵣₜₐₗ/A_{1,tot}) in equation 4 is known as the “acoustic coupling factor” from Space X to Space Y which indicates the fraction of the source power in Space X that is transferred to Space Y under steady-state conditions.

As can be seen, the acoustic coupling factor is equal to the fraction of the total amount of absorption in Space X that is due to the portal. In other words, the power that is transferred from Space X to Space Y is determined by the fraction of the total amount of absorption A_{1,tot} in Space X that is represented by the size Sₚₒᵣₜₐₗ of the portal.

If the amount of absorption A_{1,0} in Space X excluding the portal is very small compared to Sₚₒᵣₜₐₗ (e.g., if the walls of Space X are highly reflective and/or the portal is a very large opening, then the acoustic coupling factor (Sₚₒᵣₜₐₗ/A_{1,tot}) is essentially equal to 1 and the amount of power that is transferred through the portal is essentially equal to the power radiated by the source.

If, on the other hand, the amount of absorption A_{1,0} in Space X excluding the portal is very large compared to Sₚₒᵣₜₐₗ (e.g., if the walls of Space X are highly absorbing and/or the portal is very small), then the acoustic coupling factor (Sₚₒᵣₜₐₗ/A_{1,tot}) is equal to (Sₚₒᵣₜₐₗ/A_{1,0}), i.e., the ratio of the size of the portal and the amount of absorption in Space X excluding the portal, which will in that case be a very small number, i.e., only a very small fraction of the source power is transferred through the portal.

The average steady-state reverberant energy density E in a space is directly related to the root-mean-square steady-state reverberant acoustic pressure in the space, p, by the following relation:

$${p}^{2} = E * {ρ}_{0} * {c}^{2} , \qquad ( 5 )$$

with ρ₀ the mass density of air.

So, using equation 1 one can write for the steady-state reverberant acoustic pressure in Space X due to source S1, p₁:

$${p}_{1}^{2} = {E}_{1 , 1} * {ρ}_{0} * {c}^{2} = 4 * {ρ}_{0} * c * ( {P}_{1} / {A}_{1 , tot} ) ) . \qquad ( 6 )$$

Combining equations 4 and 6, we find a relation between the steady-state reverberant pressure p₁ in Space X and the power that is transferred to Space Y:

$${P}_{1 - > 2} = ( {S}_{portal} / ( 4 * {ρ}_{0} * c ) ) * {p}_{1}^{2} . \qquad ( 7 )$$

So, equation 7 provides an expression for the amount of power that is transferred from Space X to Space Y in terms of the diffuse acoustic pressure in Space X, p₁, and the size of the portal Sₚₒᵣₜₐₗ. Importantly, equation 7 shows that if we know the diffuse acoustic pressure in Space X and the size of the portal, then this directly gives us the amount of power that is transferred through the portal.

Now, to arrive at an expression for the relationship between the diffuse acoustic pressure p₁ in Space X and the acoustic pressure p₂ in Space Y associated with the radiation through the portal, a relationship is needed between the power P_{1->2} that is transferred through the portal, and the resulting pressure p₂ in Space Y.

If the portal is relatively small, then we can assume that the reverberant energy that is transferred through the portal is radiated equally into all directions (i.e., spherically) from the portal into Space Y. With this assumption, this results in a pressure p_{2,1m} at 1 m distance from the portal equal to:

$${p}_{2 , 1 m}^{2} = 2 * {P}_{1 - > 2} * {ρ}_{0} * c / 4 π . \qquad ( 8 )$$

This follows from the relationship between acoustic source power P and pressure p at 1 m distance of a source radiating spherical waves:

$${p}^{2} = P * {ρ}_{0} * c / 4 π , \qquad ( 9 )$$

where in equation 8 a factor of 2 has been added to the power since the power P_{1->2} is radiated only into the half-sphere on the Space Y side of the portal (hence, the resulting pressure should be the pressure corresponding to a full-sphere radiating source of twice that power).

Combining equations 7 and 8, one finds the following relationship between the diffuse pressure p₁ in Space X and the rms pressure p_{2,1m} at 1 m distance from the portal in Space Y:

$${p}_{2 , 1 m}^{2} = ( {S}_{portal} / 8 π ) * {p}_{1}^{2} . \qquad ( 10 )$$

In terms of audio signal levels in an audio rendering system, the rms acoustic pressure p is directly proportional to the rms signal level of the corresponding audio signal, so that equation 10 provides a direct way to relate the desired rms audio signal level in Space Y to the rms reverberation audio signal level in Space X.

So, in terms of linear acoustic pressure or linear rms audio signal level, equation 10 means that the reverberation of Space X should be rendered from the portal into Space Y with a scaling such that at 1 m from the portal the resulting acoustic pressure or rms audio signal level is scaled by a factor of {square root over (Sₚₒᵣₜₐₗ/8π))} relative to the diffuse acoustic pressure or rms audio signal level of the reverberation in Space X.

In terms of logarithmic sound pressure level or logarithmic rms audio signal level (in dB), this means that the reverberation of Space X is rendered in Space Y such that the resulting level at 1 m from the portal is 10*log₁₀ (Sₚₒᵣₜₐₗ/8π)=10*log₁₀ (Sₚₒᵣₜₐₗ)−14 (dB) relative to the diffuse sound pressure level or rms audio signal level in Space X.

As mentioned, this result is valid for portals that are sufficiently small, such that the assumption of spherical radiation from the portal is reasonable. It is obvious that there are limits to the applicability of equation 10, because if the size Sₚₒᵣₜₐₗ of the portal exceeds 8π m², then the rms pressure p_{2,1m} in Space Y would be larger than the rms pressure p₁ in Space X, which physically can never be the case. In fact, since the acoustic power that is associated with the pressure p_{2,1m} only corresponds to the part of the diffuse sound field in Space X that is incident on the opening, i.e., it corresponds to at maximum the diffuse sound power from the half-sphere on the Space X side of the opening,

$${p}_{2 , 1 m}^{2}$$

should never exceed

$$0.5 * {p}_{1}^{2} .$$

The reason why equation 10 can give physically implausible results for large values of Sₚₒᵣₜₐₗ is that the use of equation 9 implies that the total power that is transferred through the portal is effectively radiated from a single point, which, if this were really the case, would indeed result in a much higher pressure close to this single point than if the power would be uniformly distributed and radiated from the whole portal (as is actually the case in reality).

One way to address this issue is by modifying equation 10 as:

$${p}_{2 , 1 m}^{2} = min \{ ( {S}_{portal} / 8 π ) , 0.5 \} * {p}_{1}^{2} . \qquad ( 11 )$$

This modification prevents that the resulting level in Space Y at 1 m from the portal can ever exceed the diffuse reverberation level in Space X minus 3 dB (=10 log₁₀ (0.5)) as the physics require (as explained above). Note that, depending on the actual rendering method that is used for rendering the reverberation coming from the portal, an additional measure may be required at distances within 1 m from the portal to ensure that the level there also does not exceed the diffuse reverberation level minus 3 dB in Space X. In other words, it should be ensured that the resulting level of the signal rendered from the portal does not exceed the diffuse reverberation level in Space X minus 3 dB anywhere in Space Y. This will also ensure a smooth transition of reverberation level when the listener moves between the spaces through the portal.

Although being a rather simple measure for solving the problem of p_{2,1m} potentially becoming too large if Sₚₒᵣₜₐₗ exceeds 4π m² (=12.6 m²), the solution of equation 11 may actually provide a very plausible effect in many use cases.

If Sₚₒᵣₜₐₗ is substantially smaller than 4π m², then the assumption of spherical radiation from the opening is reasonable and using Sₚₒᵣₜₐₗ/8π as scaling factor gives a plausible result.

As the size of the portal is increased and approaches 4π m², the sound pressure level at 1 m from the portal approaches the sound pressure level of the reverberation in Space X minus 3 dB, finally reaching and remaining at that level for portals larger than 4π m². The latter seems quite plausible, because the reverberation experienced when standing at 1 m distance from the center of an opening with a size of, for example, 4×3 m (=12 m²) is very similar to when standing in the opening itself.

From the derived rms pressure at 1 m from the portal, p_{2,1m}, it is straightforward to derive the rms acoustic pressure p₂ at any position in Space Y at an arbitrary distance d from the portal, from: p₂(d)=p_{2,1m}/d.

Alternatively, other models for modeling the radiation from the portal may be used instead of the spherical radiation model of equations 8 and 9, leading to alternative equations to equation 8 for the relationship between the transferred power P_{1->2} and the resulting pressure p₂ in Space Y, and the resulting relationship between the pressures p₁ and p₂ of equations 10 and/or 11 (and, as a result, the scaling that is eventually applied to the audio signal rendered from the portal in order to obtain the correct rendered audio signal level in Space Y).

For example, the reverberation portal source may be modeled as a spatially diffuse extended sound source, e.g., a spatially diffuse line source or planar source having a size equal to the geometrical size of the portal. Acoustic radiation models for such spatially diffuse extended sources, relating the acoustic source power to the resulting acoustic pressure at a given distance from the source, are available in the literature.

So, in some embodiments an alternative equation to equation 10 or 11 may be used of the form:

$${p}_{2 , 1 m}^{2} = C 1 * {S}_{portal} * {p}_{1}^{2} , \qquad ( 12 )$$

with C1 a constant, or even more generally:

$${p}_{2 , 1 m}^{2} = f ( {S}_{portal} ) * {p}_{1}^{2} , \qquad ( 13 )$$

where f(Sₚₒᵣₜₐₗ) is a function of the portal size Sₚₒᵣₜₐₗ.

### Alternative Theoretical Framework

An alternative but to a large extent equivalent theoretical view on the transfer of reverberation from Space X to Space Y will be presented.

Because a theoretical diffuse reverberant sound field in each point in a space is made up of equally strong uncorrelated plane waves arriving from all directions, the amount of reverberant energy that propagates from Space X through the portal to a specific point in Space Y, can be determined by geometrical considerations.

If the average (rms) pressure of an individual reverberant plane wave arriving from a single solid angle dΩ to an arbitrary point in Space X is denoted as p_{d}, then the rms diffuse reverberant pressure in any point in Space X, p₁, follows from integrating p_{d} over all solid angles dΩ:

$${p}_{1}^{2} = \int {p}_{d}^{2} d Ω = 4 π {p}_{d}^{2} . \qquad ( 14 )$$

FIG. 11B shows a point L in Space Y and indicated is the opening angle when “looking” from point L into Space X through the portal. From the viewpoint of point L, the portal represents a solid angle Ωₚₒᵣₜₐₗ (with 0≤Ωₚₒᵣₜₐₗ≤2π).

Because the diffuse field in Space X by definition consists of equally strong uncorrelated plane waves from all direction, and because the pressure of a plane wave is constant along its path (i.e., it is independent of the distance travelled) each individual plane wave that reaches point L in Space Y through the portal contributes the same uncorrelated pressure component p_{d}, and the resulting pressure p₂ at point L in Space Y can therefore be determined from integrating pa over the solid angle Ωₚₒᵣₜₐₗ that the portal represents at point L (where 0≤Ωₚₒᵣₜₐₗ≤2π):

$${p}_{2}^{2} = {\int }_{{Ω}_{portal}} {p}_{d}^{2} d Ω = {Ω}_{portal} {p}_{d}^{2} . \qquad ( 15 )$$

Combining equations 14 and 15, it follows that the pressure p₂ at point L in Space Y can be determined directly from the solid angle Ωₚₒᵣₜₐₗ and the diffuse pressure in Space X, p₁.

$${p}_{2}^{2} = ( {Ω}_{portal} / 4 π ) {p}_{1}^{2} . \qquad ( 16 )$$

In case the portal is not fully acoustically transparent but transmits a fraction T of the power that is incident on it, then p₂ is scaled accordingly.

This result can be compared to equations 10-12, and like those equations it expresses that the squared rm pressure in Space Y is directly proportional to the squared rms pressure in Space X, with the proportionality factor being linearly dependent on the size of the portal, where the size of the portal is expressed in terms of (equivalent) area (m²) in equations 10-12, and in terms of solid angle in equation 16.

The diffuse reverberant pressure in Space X, p₁, may be determined from the power of the sound source and the amount of acoustic absorption in Space X, according to equation 6.

One thing to note when comparing the two theoretical frameworks presented, is that while the first framework models the portal as a “secondary” sound source that radiates into Space Y, the second framework directly considers the reverberant energy that is received from Space X at a specific point in Space Y. Since the solid angle that the portal represents depends on the position relative to the portal, the pressure p₂ that results from equation 16 is dependent on the relative position of the specific position also.

Specifically, the pressure resulting from equation 16 will be very different for positions right in front of the portal, and positions to the side of (or above/below) the portal.

If the portal is sufficiently small, then the solid angle represented by a flat surface portal with a geometrical area of Sₚₒᵣₜₐₗ m² at a distance r from the observation point can be approximated by:

$${Ω}_{portal} \approx 4 π * ( {S}_{portal} / 4 π {r}^{2} ) * innerproduct ( \vec{r} , \vec{n} ) , \qquad ( 17 )$$

with \vec{r} and \vec{n} the position vectors from the observation point to the portal and the normal vector of the portal, respectively.

At a distance of r=1 m, this becomes:

$${Ω}_{portal} \approx {S}_{portal} * cos θ , \qquad ( 18 )$$

with θ the observation angle with respect to the normal vector of the portal.

Combining equation 18 with equation 16, we see that for a position right in front of the portal, Ωₚₒᵣₜₐₗ≈Sₚₒᵣₜₐₗ, and;

$${p}_{2}^{2} \approx ( {S}_{portal} / 4 π ) {p}_{1}^{2} .$$

Comparing unis to equation 10, we see that the rms pressure at 1 m following from equation 16 is a factor sqrt(2) larger than the rms pressure at 1 m from equation 10. On the other hand, at a position completely to the side of the portal, Ωₚₒᵣₜₐₗ≈0, and, as a consequence, also

$${p}_{2}^{2} \approx 0 .$$

This can be interpreted as that while equation 16 represents the pressure at a specific point in Space Y, equation 10, being derived from an assumption of spherical radiation from the portal, represents the average of equation 16 at 1 m distance over all angles (i.e., the average value of the solid angle Ωₚₒᵣₜₐₗ over all angles at 1 m from the portal is equal to Sₚₒᵣₜₐₗ/2).

In the above, it has been assumed that Space Y is free-field, i.e., a space that does not generate any diffuse reverberation itself space (e.g., a large outdoor space).

### Rendering

An XR audio renderer can be configured to make use of the above models to make a plausible rendering of reverberation in connected spaces of an XR environment.

In one embodiment, the rendering of reverberation that is associated with reverberation generated in Space X, in a second, connected, Space Y, is split into two stages: (1) the rendering of the reverberation from Space X that directly reaches a listener in Space Y via the portal between the two spaces and (2) the generation and rendering of reverberation that is generated in Space Y, in response to the reverberation from Space X that enters Space Y through the portal.

In some embodiments only the first rendering stage may be carried out. In other embodiments only the second embodiment may be carried out. In yet other embodiments both rendering stages may be carried out,

### The First Rendering Stage

The first rendering stage is essentially independent of the acoustics of Space Y. It is the reverberant sound that, e.g., a listener standing in a large open-air space would hear coming out of the open doors (i.e., the portal) of a cathedral in which music is being played.

In one embodiment, the level of the sound to be rendered in Space Y as a result of a reverberant sound field in Space X may comprise the following steps:
(1) Determining, from one or more reverberation signals representing reverberation in Space X (a.k.a., “Space X reverberation signals”), a Space X reverberation strength value representing the strength of the reverberation in Space X;
(2) Deriving, from the one or more Space X reverberation signals, one or more Space Y reverberation signals for rendering in Space Y (e.g., a downmix signal);
(3) Obtaining (e.g., determining, deriving, receiving) a size of a portal through which sound is transmitted between Space X and Space Y;
(4) Determining a scaling factor that models the transmission of reverberant sound from Space X to Space Y using the portal size; and
(5) Rendering one or more transmitted reverberation signals in Space Y, using the Space Y reverberation signals, the Space X reverberation strength value, and the scaling factor.

With respect to the first step, the Space X reverberation strength value may be determined in various ways.

In a simple scenario in which the reverberation in Space X is rendered from a single (i.e., non-directional, monophonic) audio signal, the Space X reverberation strength value may simply be determined as the rms amplitude or rms power of that signal, or in case the reverberation is rendered on the basis of an impulse response, as the total amount of energy contained in the impulse response.

In case the reverberation in Space X is rendered using multiple audio signals, e.g., as multiple uncorrelated signals rendered from a number of directions around the user, then the Space X reverberation strength value may be determined as the rms amplitude or power of the resulting, combined signal. As an example, suppose that the reverberation in Space X is rendered to a listener in Space X as N uncorrelated reverberation signals from N corresponding directions, each having an rms amplitude of 1/N (or rms power of 1/N²), then the resulting, combined reverberation signal has an rms power of 1/N and an rms amplitude of 1/sqrt(N).

In some cases, the Space X reverberation strength value does not have to be determined from actual Space X reverberation audio signals but can be derived more efficiently from reverberation strength metadata for Space X. For example, the scene description metadata for the XR scene may contain a reverb level parameter or a reverb energy ratio parameter for Space X that describes the desired reverberation level in Space X, either absolute or relative to the direct sound level or emitted source energy of a source in Space X that generates the reverberation. In such a case, the (relative) reverberation level in Space X is known a-priori (and it is the renderer's job to generate the Space X reverberation audio signals such that they result in the specified reverberation level in Space X). For example, suppose that Space X has associated metadata that includes a value for the reverberant-to-direct energy ratio (RDR) in Space X, which specifies the desired ratio of the energy of the reverberation and the energy of the direct sound at 1 m distance from an omnidirectional audio source positioned somewhere in Space X. Now, if an omnidirectional audio source in Space X has an associated audio signal with a linear rms signal amplitude s, and an associated linear source gain (“volume control”) g, then the rendered linear rms signal amplitude of the direct sound at 1 m from the audio source is given by g*s, so that the rms power/energy of the direct sound signal is (proportional to) (g*s)². From this it follows that the rms energy/power of the reverberation associated with the audio source should be equal to RDR*(g*s)², so that the linear rms signal amplitude of the reverberation is sqrt(RDR)*g*s. So, the Space X reverberation strength value may be derived directly from the provided reverberation energy ratio (RDR) parameter for Space X and the source gain and audio signal level of the audio source.

If the source is not omnidirectional but has an arbitrary directivity pattern associated with it which results in the source radiating a fraction X of the power of an omnidirectional source (for the same source signal), then this results in the power of the resulting reverberation also being a fraction X of that for an omnidirectional source. So, the derived Space X reverberation strength value should be scaled accordingly, i.e., by a factor sqrt(X) if expressed in terms of linear rms signal amplitude, or by a factor X if expressed in terms of rms signal energy/power.

Other source rendering aspects that, in addition to the source gain g, signal level s and directivity pattern discussed above, affect the gain of either the rendered direct sound level or the rendered reverberation level, may be taken into account in the calculation of the Space X reverberation strength value in a similar way.

With respect to step 2, the step of deriving the one or more Space Y reverberation signals for rendering in Space Y may be done in various ways. In one embodiment, a Space Y reverberation signal may be a monophonic downmix from the one or more Space X reverberation audio signals.

In another embodiment, the one or more Space Y reverberation signals may be derived directly from a source signal and Space X reverberation metadata parameters, e.g., reverberation time RT60 and reverberation energy ratio parameters, i.e., without the intermediate step of first generating actual Space X reverberation signals. This may be more efficient, since the Space X reverberation signals are not actually rendered to the listener (being located in Space Y) and are only generated as an intermediate step in generating the one or more Space Y reverberation signals.

With respect to step 3, the size of the portal may be obtained in various ways. In some embodiments, a size of the portal may be directly available in scene description data that may explicitly specify the position and/or size of portals in a space and to which other space it connects. In other embodiments, the size may be derived from such scene description data, e.g., from geometry information. In yet other embodiments, the size of the portal may be detected heuristically, e.g., using some form of ray-tracing algorithm.

In some embodiments, the size of the portal represents the area of the portal in m². In some embodiments, the area is an equivalent area of an acoustically fully transparent opening having the same amount of “acoustic power leakage” as the portal.

In other embodiments, the size of the portal represents the solid angle corresponding to the portal from a specific position in Space Y. Methods for deriving the solid angle are readily available in literature.

The scaling factor derived in step 4 represents the desired relationship between the strength (e.g., rms diffuse pressure, rms signal amplitude or rms signal power) of the reverberation in Space X, and the strength (e.g., rms diffuse pressure, rms signal amplitude or rms signal power) of the rendered Space Y reverberation signals in Space Y.

In many embodiments, the basis for deriving the scaling factor may be given by any one of the equations 10-13 or 16, from which it may be derived as the factor that relates p₁ to p₂, or, alternatively, p₁² to p₂².

So, for example, the scaling factor may be derived from equation 10 as being equal to (Sₚₒᵣₜₐₗ/8π) (or its square root), while from equation 16 it may be derived as (Ωₚₒᵣₜₐₗ/4π) (or its square root).

Finally, the derived one or more Space Y reverberation signals are rendered to a listener in Space Y, using the Space X reverberation strength value and the scaling factor.

The scaling factor and Space X reverberation strength value together determined the desired strength of the rendered Space Y reverberation signal(s), through the relationship: desired strength of rendered Space Y reverberation signal(s)=scaling factor x Space X reverberation strength value.

Having determined the desired strength for the rendered Space Y reverberation signal(s), an appropriate scaling gain can be determined for the Space Y reverberation signal(s) that achieves this desired strength of the rendered Space Y reverberation signals.

In some embodiments, the scaling gain for the Space Y reverberation signal(s) is simply equal to the scaling factor.

In some embodiments, the scaling gain for the Space Y reverberation signals may, in addition to the scaling factor, account for gain effects that are due to the specific way in which the Space Y reverberation signal(s) are derived from the Space X reverberation signals, as well as for gain effects that arise due to different signal representations and rendering methods used for the Space X and Space Y reverberation signals.

As already explained, the Space X reverberation may be represented by (and rendered as) a combination of multiple signals from which the Space Y reverberation signals are derived using some signal transformation (e.g., downmix) process, which may introduce some transformation gain effect, i.e., a difference in the signal strength before and after the transformation. The scaling gain for the Space Y reverberation signal(s) may compensate for this gain effect.

The scaling gain for the Space Y reverberation signals may also compensate for gain effects that result from the specific ways in which the reverberation signals are combined in the specific Space X and Space Y rendering methods used.

As a simple example, refer to the earlier example where the Space X reverberation is represented by N uncorrelated signals that are rendered from different directions around a listener in Space X, with each signal having an rms amplitude of 1/N. The Space X reverberation strength value in this case is the rms amplitude of the sum of the N uncorrelated signals, which is equal to 1/sqrt(N). Suppose now that the Space Y reverberation is derived from the Space X reverberation signals by simply selecting one of the N signals, which has an rms amplitude of 1/N. If this Space Y reverberation signal is now rendered as a point source located at some position within the portal and a scaling factor according to equation 10 of (Sₚₒᵣₜₐₗ/8π), then an extra gain of sqrt(N) has to be applied to the Space Y reverberation signal in order to obtain the correct balance between the strengths of the reverberation in Space X and Space Y.

So, the basic idea is that the Space Y reverberation signals are scaled such that the resulting strength of the rendered Space Y reverberation signal(s) has the desired relationship to the strength of the Space X reverberation as expressed by the scaling factor.

As discussed earlier, different rendering methods may be used for rendering the derived Space Y reverberation signals.

In one embodiment, the sound that is transmitted through the portal is rendered to the listener as a sound source positioned within the portal, i.e., a portal sound source. In one embodiment, the portal sound source is an extended sound source having a size corresponding to the geometric size of the portal. The extended sound source may be a homogeneous extended sound source-radiating the same signal from every point within the extent, a diffuse extended sound source-radiating spatially diffuse signals from different points within the extent, or a heterogeneous extended sound source-radiating partially correlated signals from different points within the extent.

In another embodiment, the portal sound source is a point source. In one embodiment, the point source is positioned at a fixed position, e.g., a central position within the portal. In another embodiment, the point source may be dynamically positioned within the portal, depending on the listener position. For example, the point source may be positioned at the point within the portal that is closest to the listener position.

### The Second Rendering Stage

In the second rendering stage, reverberation is generated in Space Y in response to the Space X reverberation that enters Space Y through the portal, according to the acoustic properties of Space Y, such as, for example, Space Y reverberation time, absorption, and/or reverberation level or reverberation energy ratio. Here, the rendering may be based on the amount of power that is transferred from Space X to Space Y, e.g., according to equation 7. The reverberation may then be generated as the reverberation of a point source positioned in Space Y having a source power equal to the transmitted power.

More specifically, the second rendering stage may comprise the following steps:
(1) Determining, from one or more Space X reverberation signals representing reverberation in Space X, a Space X reverberation strength value representing the strength of the reverberation in Space X;
(2) Deriving, from the one or more Space X reverberation signals, one or more reverberation input signals for generating reverberation in Space Y (e.g., a downmix signal);
(3) Obtaining (e.g., determining, deriving, receiving) a size of a portal through which sound is transmitted between Space X and Space Y;
(4) Determining a scaling factor that models the transmission of reverberant sound from Space X to Space Y using the portal size; and
(5) Rendering a reverberation signal in Space Y, using the Space Y reverberation signal(s), the Space X reverberation strength value, and the scaling factor.

So, the steps for the second rendering stage are basically the same as for the first rendering stage, but some of the details are different, as will be explained below.

Steps 1 and 3 are the same as for the first rendering stage. So, if both the first and second rendering stage are carried out, steps 1 and 3 only have to be carried out once.

In step 2, a signal is derived that is used for generating reverberation in Space Y. Typically, only a single reverberation input signal may be required. So, if the step 2 in the first rendering stage produces a single (e.g., mono downmix) signal, then that can also be used as reverberation input signal for the second rendering stage. In principle, any signal having the general characteristics of the reverberation in Space X may be used as reverberation input signal in the second rendering stage, e.g., a single one out of multiple Space X reverberation signals, or a single reverberation signal from which the multiple Space X reverberation signals are generated.

In step 4, the scaling factor may be equal to (Sₚₒᵣₜₐₗ/16π), i.e., a factor of 2 smaller than in the first rendering stage when using the model of equation 10. The reason for this is that in the second rendering stage, the reasoning that led to the addition of the factor of 2 in equation 8 does not apply here, and it is the “normal” relationship between source power an pressure of an omnidirectional point source of equation 9 that should be used.

Finally, in step 5 Space Y reverberation is generated in accordance with the reverberation characteristics (e.g., reverberation time, reverberation energy ratio) corresponding to Space Y, using a scaled version of the derived reverberation input signal as source signal. The scaling factor and Space X reverberation strength value are used to scale the gain of the reverberation input signal that is used to generate the Space Y reverberation. The scaling is such that when the scaled signal would be rendered as a point source, it would have the desired level at 1 m distance from the point source, i.e., p_{2,1m}²=scaling factor x p₁². Reverberation is now generated from the scaled reverberation input signal, resulting in reverberation with the desired strength.

### Further Rendering Aspects

If, like in a typical implementation, the reverberation from Space X is rendered from the portal into Space Y as an extended sound source (also known as a “volumetric” or “sized” sound source) located at and having the same geometrical size as the portal, then the result using the equation 11 will be even more realistic than if the sound from the portal is rendered as a point source located at a fixed point within the portal. In such an implementation using an extended portal sound source, as used for example in the MPEG-I Immersive Audio standard, the distance to the extended sound source, i.e., the portal, is typically not measured relative to some reference point (e.g., center point) in the portal, but relative to the closest point of it. This means that if a user would (virtually) walk along a path parallel to a large portal, the distance to the portal, i.e., the distance that is used in rendering the extended sound source to the user, remains constant, meaning that the sound level experience by the user also remains constant along this path, just as would be expected. (In contrast, if the sound coming from the portal would be rendered as a point source at a fixed position within the portal, the distance, and thus the rendered sound level, would change as the user moves along the portal).

A similar effect can be achieved if the sound from the portal is rendered to the user in Space Y as a point source positioned at a dynamic position within the portal that moves along with the user, instead of being at a fixed position within the portal. In this case, the portal point source is dynamically positioned at the position within the portal that is closest to the user.

Furthermore, in implementations using an extended sound source for rendering the sound from the portal as described above, a distance attenuation function may typically be applied to the sound rendered from the extended portal sound source that takes into account the geometrical size of the extended sound source as viewed from the listening position, which may make the perceived effect even more realistic. For example, if the listening position is initially in front of and relatively close to the portal, the extended portal source may behave as a diffuse planar sound source and its rendered sound level may decrease only relatively slowly if the distance from the portal is increased along a trajectory perpendicular to the portal. As the distance is increased further, the level decrease rate with increasing distance becomes more rapid, eventually approaching the decrease rate of a point source.

On the other hand, if the listening position is initially at a side of the portal, the “perceived” geometric size of the extent of the volumetric source, i.e., its geometrical size as “viewed” from the listener position, is much smaller than when standing right in front of it. If the distance is now increased while keeping the angle to the portal the same, then the rendered sound level decreases more rapidly with increasing distance than was the case for the listening trajectory in front of the portal.

### Cascading Connected Spaces

In case more than two spaces are connected to each other, the propagation of reverberation from one space to all the other spaces through the respective portals can be modeled by repeated application of equation 7 and/or equation 4 that models the amount of reverberant power transferred through a portal from one space to the next. For example, if three Spaces 1, 2 and 3 are connected via a first portal between Space X and Space Y, and a second portal between Space Y and Space X, then the amount of reverberation power transferred to Space X due to a sound source in Space X may be determined from first applying equation 7 to determine the power transferred to Space Y via the first portal from the diffuse reverberant pressure in Space X. Using this determined transferred power level, reverberation can be generated in Space Y in accordance with the Space Y acoustic parameters (e.g., RT60 and reverberation energy ratio), providing the diffuse reverberant pressure in Space Y. Then, applying equation 7 to this Space Y diffuse reverberant pressure, the amount of power transferred to Space X via the second portal may be calculated.

Alternatively to the step of rendering the reverberation in Space Y based on the determined amount of power from Space X to Space Y and determining the diffuse reverberant pressure in Space Y from that, the amount of power transferred to Space X may also be determined directly by applying equation 4 to the result of the first step, i.e., with the amount of power transferred from Space X to Space Y obtained in the first step as P₁ in equation 4. The only issue here is that applying equation 4 requires the amount of absorption in Space Y, A_{1,tot} (or A_{1,0}), which may not be directly available as metadata. In this case, the amount of absorption may be estimated from available parameters, specifically the reverberation energy ratio or the combination of reverberation time RT60 and volume of Space Y. Patent application P103111 describes methods for deriving the amount of absorption from these other parameters.

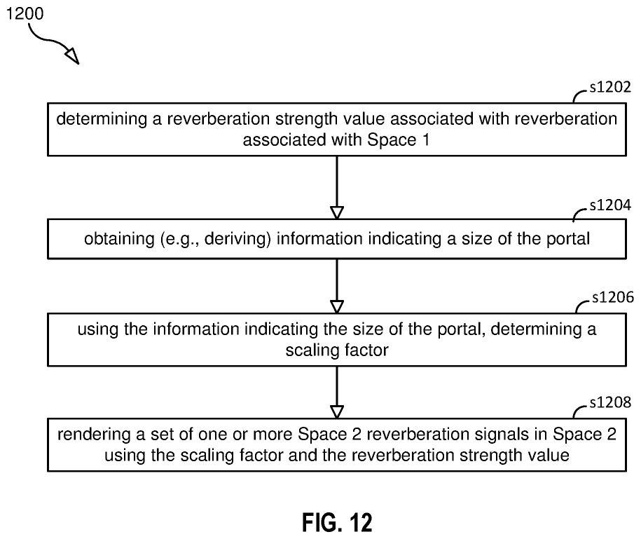

FIG. 12 is a flowchart illustrating a process 1200 according to some embodiments for rendering reverberation in Space Y connected to Space X via a portal. Process 1200 may be performed by audio renderer 151. Process 1200 may begin with step s1202.

Step s1202 comprises determining a reverberation strength value associated with reverberation associated with Space X.

Step s1204 comprises obtaining (e.g., deriving) information indicating a size of the portal.

Step s1206 comprises using the information indicating the size of the portal, determining a scaling factor.

Step s1208 comprises rendering a set of one or more Space Y reverberation signals in Space Y using the scaling factor and the reverberation strength value.

### Summary of Various Further Additional Embodiments

A1. A method performed by an audio renderer for rendering reverberation in Space Y, connected to Space X via a portal, the method comprising: determining a reverberation strength value associated with reverberation associated with Space X; obtaining (e.g., deriving) information indicating a size of the portal; using the information indicating the size of the portal, determining a scaling factor; and rendering a set of one or more Space Y reverberation signals in Space Y using the scaling factor and the reverberation strength value.

A2. The method of embodiment A1, wherein a set of one or more reverberation signals represent a reverberation sound field in Space X (this set of one or more signals is referred to as “Space X reverberation signals”), and the method further comprises, prior to rendering the Space Y reverberation signal(s), deriving, the set of one or more Space Y reverberation signals from the Space X reverberation signals.

A3. The method of embodiment A2, wherein determining the reverberation strength value comprises determining the reverberation strength value based on the set of one or more Space X reverberation signals.

A4. The method of embodiment A2 or A3, wherein deriving the set of one or more Space Y reverberation signals for rendering in Space Y comprises down-mixing the set of one or more Space X reverberation signals.

A5. The method of any one of embodiments, A1-A4, wherein the information indicating the size of the portal is a size value, Sₚₒᵣₜₐₗ, and determining the scaling factor comprises calculating C1*Sₚₒᵣₜₐₗ, where C1 is a predetermined value.

A6. The method of embodiment A5, wherein C1 is approximately 1/8π.

A7. The method of embodiment A5 or A6, wherein determining the scaling factor further comprises calculating the square root of C1*Sₚₒᵣₜₐₗ.

A8. The method of embodiment A5 or A6, wherein determining the scaling factor further comprises determining whether C1*Sₚₒᵣₜₐₗ is less than C2, where C2 is a predetermined number (e.g., 0.5).

A9. The method of any one of embodiments, A1-A4, wherein the information indicating the size of the portal is a solid angle value, Ωₚₒᵣₜₐₗ.

A10. The method of embodiment A9, wherein determining the scaling factor comprises calculating C1*Ωₚₒᵣₜₐₗ, where C1 is a predetermined value (e.g., C1=1/4π).

A11. The method of embodiment A10, wherein determining the scaling factor further comprises calculating the square root of C1*Ωₚₒᵣₜₐₗ.

### CONCLUSION

While various embodiments are described herein, it should be understood that they have been presented by way of example only, and not limitation. Thus, the breadth and scope of this disclosure should not be limited by any of the above described exemplary embodiments. Moreover, any combination of the above-described objects in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] WD1 of ISO/IEC 23090-4, MPEG-I Immersive Audio, output document of the 9 th meeting of MPEG WG 6 Audio Coding; and
[2] O. Das and J. S. Abel, “Grouped Feedback Delay Networks for Modeling of Coupled Spaces” J. Audio Eng. Soc., vol. 69, no. 7/8, pp. 486-496, (2021 July/August). DOI: https://doi.org/10.17743/jaes.2021.0026.

1. A method for producing an input signal for a first space of an extended reality (XR) scene based on a first sound source in a second space of the XR scene, wherein the first space is connected, either directly or indirectly, to the second space via one or more portals including at least a first portal, the method comprising:
obtaining a direct propagation value, wherein the direct propagation value is indicative of an amount or portion of source power associated with the first sound source in the second space that is propagated directly from the first sound source through the one or more portals into the first space; and
producing the input signal for the first space using the direct propagation value and an audio signal associated with the first sound source.

2. The method of claim 1, wherein the method further comprises using the input signal for the first space to generate a reverberation signal for the first space.

3. The method of claim 2, wherein the reverberation signal for the first space is generated using reverberation control information associated with the first space.

4. The method of claim 3, wherein the reverberation control information comprises a reverberation level or reverberation energy ratio parameter associated with the first space.

5. The method of claim 2, wherein the method further comprises rendering the reverberation signal.

6. The method of claim 1, wherein s1=sqrt(X)*G*s2, where
s1 is the input signal for the first space,
X is the direct propagation value,
G is a gain factor, and
s2 is the audio signal associated with the first sound source.

7. The method of claim 1, wherein
the method further comprises receiving metadata associated with the XR scene,
the metadata comprises the direct propagation value or data from which the direct propagation value can be derived, and
obtaining the direct propagation value comprises obtaining the direct propagation value from the metadata or obtaining the direct propagation value using the data.

8. (canceled)

9. The method of claim 1, wherein obtaining the direct propagation value comprises deriving the direct propagation value using information indicating a position of the first sound source in the second space and one or more of:
i) information indicating a position of the first portal,
ii) information indicating a size of the first portal, and
iii) information indicating a shape of the first portal.

10. The method of claim 9, wherein
one or more of: information indicating a directivity pattern of the first sound source or information indicating an orientation of the first sound source is also used to derive the direct propagation value, or
information indicating a directivity pattern of the first sound source and/or information indicating an orientation of the first sound source is/are also used to derive the direct propagation value.

11. The method of claim 1, wherein
the method further comprises receiving metadata associated with the XR scene,
the metadata comprises portal position information indicating the positions of the one or more portals, and
obtaining the direct propagation value comprises deriving the direct propagation value using the portal position information.

12. The method of claim 11, wherein, for each portal, the metadata comprises information indicating a geometry of the portal.

13. The method of claim 1, wherein
the first portal is associated with a transmission coefficient, and
the direct propagation value is obtained using the transmission coefficient.

14. The method of claim 1, wherein obtaining the direct propagation value comprises obtaining the direct propagation value using an interpolated grid of pre-calculated values and information indicating a position of the first sound source.

15. The method of claim 1, wherein obtaining the direct propagation value comprises:
forming a mesh representing the first portal;
determining an area of the mesh; and
using the area of the mesh to calculate the direct propagation value.

16. The method of claim 1, wherein obtaining the direct propagation value comprises:
projecting edges of the first portal on a sphere around the sound source;
determining a surface area of a sphere segment covered by the projection of the first portal to obtain a value; and
normalizing the obtained value by the surface area of the sphere, wherein the direct propagation value is the normalized value.

17. The method of claim 1, wherein obtaining the direct propagation value comprises:
projecting edges of the first portal on a sphere around the sound source;
integrating a directivity pattern associated with the sound source over a sphere segment covered by the projection of the first portal to obtain a value; and
normalizing the obtained value by the surface area of the sphere, wherein the direct propagation value is the normalized value.

18. (canceled)

19. The method of claim 1, wherein the first portal has eight vertices.

20. The method of claim 1, wherein a geometry of the first portal is converted into a box by enclosing the portal geometry with a box.

21. The method of claim 1, wherein the method further comprises:
using the input signal for the first space to generate a first reverberation signal for the first space;
obtaining a first scaling factor, wherein the first scaling factor is indicative of an amount or portion of reverberant energy associated with the first reverberation signal that is propagated through the one or more portals into the second space;
producing a second input signal for the second space using the first scaling factor and the first reverberation signal; and
using the second input signal for the second space to generate a second reverberation signal for the second space.

22. A method for enabling the rendering of reverberation in a first space of an extended reality (XR) scene connected, either directly or indirectly, to a second space of the XR scene via one or more portals including at least a first portal, wherein a sound source is present in the second space, the method comprising:
determining a direct propagation value, wherein the direct propagation value is indicative of an amount or portion of source power associated with the sound source, that is propagated directly from the sound source in the second space through the one or more portals to the first space; and
storing and/or transmitting the direct propagation value or data from which the direct propagation value can be derived.

23-27. (canceled)

28. A method for rendering of first-order reverberation in a first space of an extended reality (XR) scene, the method comprising:
determining whether a first sound source is located in a second space;
determining whether there are one or more portals connecting the first space with the second space;
as a result of determining that a first sound source is located in the second space and that there is at least a first portal connecting the first space with the second space, determining a first direct propagation value for the first sound source with respect to the first portal;
producing an input signal for the first space using the direct propagation value and an audio signal associated with the first sound source; and
using the input signal for the first space to generate a reverberation signal for the first space.

29-49. (canceled)

50. An apparatus for producing an input signal for a first space of an extended reality (XR) scene based on a first sound source in a second space of the XR scene, wherein the first space is connected, either directly or indirectly, to the second space via one or more portals including at least a first portal, the apparatus being configured to:
obtain a direct propagation value, wherein the direct propagation value is indicative of an amount or portion of source power associated with the first sound source in the second space that is propagated directly from the first sound source through the one or more portals into the first space; and
produce the input signal for the first space using the direct propagation value and an audio signal associated with the first sound source.

51-53. (canceled)

54. An apparatus for rendering of first-order reverberation in a first space of an extended reality (XR) scene, the apparatus being configured to:
determine whether a first sound source is located in a second space;
determine whether there are one or more portals connecting the first space with the second space;
as a result of determining that a first sound source is located in the second space and that there is at least a first portal connecting the first space with the second space, determine a first direct propagation value for the first sound source with respect to the first portal;
produce an input signal for the first space using the direct propagation value and an audio signal associated with the first sound source; and
use the input signal for the first space to generate a reverberation signal for the first space.

55. (canceled)

56. The apparatus of claim 50, wherein the apparatus is further configured to use the input signal for the first space to generate a reverberation signal for the first space.
